(19) United States
(12) Patent Application Publication
(10) Pub. No.: US 2025/0341649 A1
(43) Pub. Date: Nov. 6, 2025

(54) SUBSURFACE GEOLOGICAL SITE FRAMEWORK

(71) Applicant: Schlumberger Technology Corporation, Sugar Land, TX (US)

(72) Inventors: Jun Tao MA, Beijing (CN); Bolei Tan, Beijing (CN); Vincenzo De Gennaro, Pau (FR); Bingtao Li, Beijing (CN); Ye Ji, Beijing (CN); Shao Yong SU, Beijing (CN); Pei Yan, Beijing (CN); Yiran An, Beijing (CN); Meng YAO, Beijing (CN)

(21) Appl. No.: 19/196,475

(22) Filed: May 1, 2025

Related U.S. Application Data
(60) Provisional application No. 63/641,892, filed on May 2, 2024.

(51) Int. Cl. G01V 1/30; G01V 1/34

(52) U.S. Cl. CPC G01V 1/306; G01V 1/345

(57) ABSTRACT

A method can include accessing data for a number of reservoir sites, where the data include at least property data for reservoir properties; performing a determination, using the property data for the reservoir sites, as to whether the reservoir properties for the reservoir sites are independent; responsive to the determination, implementing a Sobol' indices technique or a Kucherenko indices technique to generate global sensitivity analysis results that include property indices for the reservoir properties; generating confidence intervals for the property indices; and generating a graphical user interface for rendering the property indices with the confidence intervals for a number of the reservoir properties.

### RELATED APPLICATION

This application claims priority to and the benefit of a U.S. Provisional Application having Ser. No. 63/641,892, filed 2 May 2024, which is incorporated by reference herein in its entirety.

### BACKGROUND

Subsurface geological sites may include various features. For example, consider minerals, geothermal energy, carbon, hydrocarbons, porous rock, voids, etc. As to minerals, these may be mined or otherwise extracted. For example, precious minerals may be mined while soluble minerals may be extracted using fluid (e.g., water). As to geothermal energy, one or more boreholes may be drilled to access geothermal energy regions where fluid may be produced that carries such energy to a facility that can provide for energy extraction (e.g., via turbine, phase-change, etc.). As to carbon, consider one or more of carbon capture, utilization, and storage (CCUS). As to hydrocarbons, consider natural gas, oil, coal, etc., which may be present in one or more types of reservoirs (e.g., consider reservoir rock, etc.). As to porous rock, it may include fluid as a resource and/or may provide a space for storage or sequestration of material (e.g., consider water storage, hydrocarbon storage, carbon storage, nuclear waste storage, etc.). As to voids, consider a cavern or a network of caverns that may be suitable for use in storage of material.

Relevant subsurface geological sites exist in many locations throughout the world. In various instances, data may be available or data may be limited. Assessing suitability of a site for one or more purposes may aim to leverage available data. Further, while a site may be deemed suitable, such a site may be suboptimal compared to one or more other sites. Making assessments and comparisons can be challenging, particularly where data or types of data may be available or unavailable, comparable or incomparable, etc. In various instances, it may not be apparent a prior what data are available or even most relevant for site assessments, comparisons, development, operations, etc.

As an example of an application for a site, CCUS, which may facilitate efforts toward one or more of reductions in atmospheric greenhouse gas (GHG), handling of GHG emissions, and achieving carbon neutrality. As an example, CO2 can be captured from a power station, an industrial source (e.g., cement factory, etc.), from natural gas production, etc. CO2 can be utilized in chemical processes, ranging from fertilizer to food production, and in enhanced oil recovery (EOR) and enhanced gas recovery (EGR), or it can be sequestered in geological structures, including saline aquifers, depleted oil and gas reservoirs, deep coal beds, etc.

As to reservoirs, a reservoir can be a subsurface formation that can be characterized by one or more physical properties. In various instances, a reservoir may be characterized at least in part by its porosity and fluid permeability. As an example, a reservoir may refer to a reservoir of minerals, a reservoir of carbon, a hydrocarbon reservoir, an aquifer, etc. For example, in mining, a mineral reservoir may refer to a geological deposit or structure where mineral resources may be concentrated. For example, consider a mineral reservoir that may be found in one or more of various forms, which may include underground deposits, surface deposits, or dissolved in solution.

As an example, a reservoir may be part of a basin such as a sedimentary basin. A basin can be a depression (e.g., caused by plate tectonic activity, subsidence, etc.) in which sediments accumulate. As an example, where hydrocarbon source rocks occur in combination with appropriate depth and duration of burial, a petroleum system may develop within a basin, which may form a reservoir that includes hydrocarbon fluids (e.g., oil, gas, etc.).

In various CO2 storage operations, a workflow can integrate aspects of CO2 storage and reservoir technologies. As an example, CO2 storage operations can depend on reservoir capacity (e.g., amount of CO2 that can be stored), reservoir injectivity (e.g., possible injection rates), and reservoir containment (e.g., stability of storage and/or risks of leakage).

CO2 operations demand an assessment of complex physical and chemical behavior of CO2 where, for example, CO2 may be a component of a hydrocarbon phase and/or an aqueous phase. Above the critical point (e.g., temperature of 31 degC and pressure of 73.8 bar) pure CO2 exists as a supercritical dense state, with gas-like viscosity and liquid-like density; whereas, below the critical point, physical properties can differ (e.g., consider CO2 as a gas or a liquid). Where oil is present, injected CO2 can become miscible with oil at high pressures. Where water is present, CO2 solubility in an aqueous phase can depend on reservoir conditions and brine composition, noting that solubility tends to increase with decreasing temperature and/or with increasing pressure and tends to decrease with increasing brine salinity.

As an example, CO2 injected into a storage site may form a gaseous plume that migrates underground, influenced by pressure gradients, gravity and buoyancy forces. CO2 may be trapped in a subsurface environment by one or more of various mechanisms, which may act over different timescales. For example, consider structural trapping where gaseous CO2 can be trapped by cap rock and/or structural features (e.g., relevant in injection and post-injection phases while gas is highly mobile); residual trapping where the gas phase is immobilized due to effects of relative permeability and capillary pressure (e.g., relevant in injection and post-injection phases while gas remains mobile); solubility trapping where CO2 dissolves into an aqueous phase (e.g., a slower process that can take hundreds or thousands of years to complete); and mineral trapping where acid formed by CO2 dissolution reacts with the reservoir rock and mineral generation occurs (e.g., a long-term process that can take many thousands of years to complete).

Interactions between CO2, water, and salts can affect solubility trapping and mineral trapping in the long term along with injectivity due to near-wellbore behavior. As CO2 gas is injected, H2O in brine can evaporate into CO2 resulting in “dry-out” in the region near the injection well, when residual water saturation can reduce to zero. This tends to increase effective permeability to CO2 such that injectivity can increase. On the other hand, in high-salinity brine there is a risk of “salting-out” as H2O evaporates. Increasing salinity can lead to halite precipitation such that permeability and porosity are reduced with an accompanying decrease in injectivity.

Total CO2 injection from worldwide CCUS projects continues to grow. To meet future goals, there will be an increase in CO2 storage activities, which will depend on selection of suitable sites, design of injection and monitoring strategies, and effective management of costs and risks.

To perform one or more CCUS operations, various workflows may be implemented. For example, consider workflows for site selection, appraisal and planning, to operations and surveillance. Workflows can involve assessments as to CO2 projects, ranging from design and construction of observation wells to 4D seismic survey monitoring and dynamic simulation of storage scenarios. 4D seismic involves performing 3D seismic surveys with respect to time, where time is the fourth dimension. The performance of such surveys, and analysis of acquired seismic survey data, demands an understanding of acoustic properties of CO2 and acoustic properties of mixtures of CO2 and hydrocarbons and/or water, particularly within one or more types of rock (e.g., consider saturated rock). With knowledge of such acoustic properties, CO2 storage workflows that integrate reservoir modeling and seismic surveying can be improved. For example, consider a CO2 storage workflow that includes reservoir simulation of injection and storage along with matching simulation results to measured field data and/or 4D seismic survey data (e.g., history matching), which can provide for improved CO2 storage operation planning and execution. Such improvements can pertain to site selection, site preparation, reservoir simulation, sensitivity analysis, seismic survey planning, seismic survey execution, seismic survey interpretation, etc.

As explained, CO2 may be injected into a subsurface reservoir that includes hydrocarbon fluids, which may be referred to as hydrocarbons. Where present, CO2, hydrocarbons, and water can be characterized in various manners. For example, their behavior can be characterized via pressure, volume and temperature analysis (PVT analysis), which can involve analysis of phase diagrams (e.g., phase plots). In a reservoir, variables such as pressure and temperature can differ spatially, which can give rise to different phases, that may be characterized as gas or liquid phases or, for example, supercritical states where properties may differ from subcritical state properties.

In a reservoir, fluid may include multiple components such as, for example, a range of hydrocarbons that can be classified according to number of carbon atoms, number of hydrogen atoms, etc. The accumulation of hydrocarbons in a reservoir can be a process that occurs over many years such that at present time (e.g., consider a time span of reservoir exploration, development and production), reservoir fluid may appear to be in an equilibrium state. Upon injection of CO2 into a reservoir, reservoir fluid and CO2 may mix, which can result in subsurface regions of mixed fluids with properties that differ from preexisting reservoir fluids.

In various reservoir simulation workflows, an interactive application such as a PVT application may be utilized. Such workflows can involve analysis of fluid samples, equations of state (EoSs), and estimating fluid variations with respect to depth and/or one or more other dimensions. Where CO2 injection and storage are to be taken into account, CO2 may be spatially distributed in a supercritical state and/or a subcritical state. Reservoir simulation and related analyses (e.g., history matching, production, operational control, etc.) can also be improved where CO2 is adequately accounted for in a subsurface region.

As explained, assessing a subsurface geological site with respect to its ability or suitability to serve one or more purposes (e.g., CO2 or other) may be relatively complex, depend on what may be an unknown number of factors, and involve considerable resources (e.g., field operations, data acquisition, computations, etc.). Where a number of possible sites may be considered candidates, screening of such candidate sites may provide for conserving resources.

### SUMMARY

A method can include accessing data for a number of reservoir sites, where the data include at least property data for reservoir properties; performing a determination, using the property data for the reservoir sites, as to whether the reservoir properties for the reservoir sites are independent; responsive to the determination, implementing a Sobol' indices technique or a Kucherenko indices technique to generate global sensitivity analysis results that include property indices for the reservoir properties; generating confidence intervals for the property indices; and generating a graphical user interface for rendering the property indices with the confidence intervals for a number of the reservoir properties.

A system can include a processor; a memory accessibly by the processor; and instructions stored in the memory and executable by the processor to instruct the system to: access data for a number of reservoir sites, where the data include at least property data for reservoir properties; perform a determination, using the property data for the reservoir sites, as to whether the reservoir properties for the reservoir sites are independent; responsive to the determination, implement a Sobol' indices technique or a Kucherenko indices technique to generate global sensitivity analysis results that include property indices for the reservoir properties; generate confidence intervals for the property indices; and generate a graphical user interface for rendering the property indices with the confidence intervals for a number of the reservoir properties.

One or more computer-readable storage media can include processor-executable instructions where the processor-executable instructions can include instructions to instruct a computing system to: access data for a number of reservoir sites, where the data include at least property data for reservoir properties; perform a determination, using the property data for the reservoir sites, as to whether the reservoir properties for the reservoir sites are independent; responsive to the determination, implement a Sobol' indices technique or a Kucherenko indices technique to generate global sensitivity analysis results that include property indices for the reservoir properties; generate confidence intervals for the property indices; and generate a graphical user interface for rendering the property indices with the confidence intervals for a number of the reservoir properties.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and examples of equipment in a geologic environment;

FIG. 2 illustrates examples of equipment in a geologic environment and an example of a system;

FIG. 3 illustrates an example of a system;

FIG. 4 illustrates an example of a system with respect to an example of a geologic environment;

FIG. 5 illustrates an example of a system with respect to an example of a geologic environment;

FIG. 6 illustrates an example of a CO2 phase diagram;

FIG. 7 illustrates an example of a phase diagram;

FIG. 8 illustrates an example of a graphical user interface;

FIG. 9 illustrates examples of plots;

FIG. 10 illustrates examples of plots;

FIG. 11 illustrates an example of a method;

FIG. 12 illustrates an example of a plot;

FIG. 13 illustrates examples of plots;

FIG. 14 illustrates an example of a graphical user interface;

FIG. 15 illustrates an example of a graphical user interface;

FIG. 16 illustrates an example of a graphical user interface;

FIG. 17 illustrates an example of a graphical user interface;

FIG. 18 illustrates an example of a graphical user interface;

FIG. 19 illustrates an example of a method and an example of a system; and

FIG. 20 illustrates example components of a system and a networked system.

### DETAILED DESCRIPTION

As explained, a subsurface geological site may be assessed for one or more purposes. As mentioned, such purposes may relate to one or more of minerals, geothermal energy, carbon, hydrocarbons, porous rock, voids, etc. In various instances, a site may be characterized by a number of relevant physical properties, which may be at one or more scales. For example, consider a spectrum from a large-scale to a micro-scale. A large-scale assessment may consider aspects such as shape, extent, volume, etc., while a micro-scale assessment may consider aspects such as rock properties (e.g., mineral content, porosity, permeability, etc.).

As mentioned, one or more minerals may be of interest at one or more sites. As an example, a mineral resource assessment may aim to estimate location, quantity, and quality of known and/or undiscovered mineral resources. Various types of decision-making may rely on mineral assessments, for example, to understand amount of a mineral resource that may be available, where future mineral development may take place, and how mineral development may impact one or more other natural resources, etc. Mineral resource assessments may depend on studies of geologic processes that result in mineral deposits, which may provide predictive power as to amount, recoverability, etc. An assessment may depend on one or more of geophysical, geochemical, and geologic data. An assessment may aim to identify locations where an appropriate combination of geologic processes may have occurred to produce a mineral deposit. As explained, deposit-forming geologic processes and related physical properties, physical phenomena, etc., may be relevant.

As to geothermal energy, an assessment may depend on a geothermal resource base characterization process. For example, consider an approach that considers thermal energy in the Earth's crust under a given area, which may be measured using temperature (e.g., mean annual temperature, etc.). The part of a resource base that may be shallow enough to be tapped by production drilling may be referred to as an accessible resource base, which may be, for example, divided into useful and residual components. In such an example, a useful component (e.g., thermal energy that may reasonably be extracted at costs competitive with other forms of energy at some specified future time) may be referred to as a geothermal resource, which may be divided into economic and subeconomic components, for example, based on conditions existing at a time of assessment. As an example, a McKelvey diagram may be utilized with a vertical axis representing degree of economic feasibility and a horizontal axis representing degree of geologic assurance with identified and undiscovered components. As an example, the term reserve may be defined as an identified economic resource. As an example, categories may be expressed in units of thermal energy, with resource and reserve figures calculated at wellhead, for example, prior to inevitable losses inherent in practical thermal use and/or in conversion to electricity. As an example, techniques for assessing geothermal resources may be grouped into classes. For example, consider one or more of the following classes: surface thermal flux, volume, planar fracture, and magmatic heat budget. As an example, a volume approach may be applied, which may be applicable to various types of geologic environments where various parameters may, in principle, be measured or estimated, errors at least in part compensated, and various uncertainties (e.g., recoverability and resupply) being amenable to some amount of resolution in a foreseeable future (e.g., a particular time span).

As to nuclear waste (e.g., radioactive waste), an assessment may involve a quantitative evaluation of potential releases of radioactivity from a disposal facility into the environment, and assessment of the resultant radiological doses. As an example, an assessment may involve a process, a model, a collection of models, etc., which may be utilized to estimate suitability, risks, etc. As an example, an assessment may depend on a selected scenario (e.g., specific features and processes at the disposal facility and in the surrounding area, such as the location of the potential release, location and general characteristics of the receptors, and applicable transport pathways through which radionuclides might reach the environment and pose a threat to the selected receptor groups). As to performance, an assessment may consider a natural, a cask (or other engineered barrier system), etc., for use to store waste, limit influx of water, and reduce possible release of radionuclides. As an example, an assessment may consider possible release and migration of radionuclides through a natural and/or an engineered barrier system. As an example, an assessment may consider deep-underground portions of a disposal site, particularly with respect to possible routes of transmission (e.g., fractures, reservoirs, etc.). An assessment may aim to consider possible networks in a subsurface geological site that may impact suitability for waste storage.

As explained, CO2 CCUS operations can rely on performing one or more of various workflows. As an example, a subsurface CO2 operational framework can improve CCUS modelling, facilitate improved characterization of subsurface reservoirs, and enhance effectiveness of carbon storage efforts.

As explained, CO2 injection can change composition of fluids that are in place in a subsurface region. In various CO2 storage reservoirs, the pressure and temperature regime will be, by design, such that injected CO2 will exist in the supercritical state of its phase diagram, thus having complex supercritical physical properties of gas and liquid. In contrast, when CO2 is injected in a depleted hydrocarbon reservoir, the CO2 can mix with residual oil and/or gas.

As explained, assessing a site with respect to its ability or suitability to for one or more purposes may be relatively complex, depend on what may be an unknown number of factors, and involve considerable resources (e.g., field operations, data acquisition, computations, etc.). Where a number of possible sites may be considered candidates, screening of such candidate sites may provide for conserving resources. As an example, a framework may provide for ascertaining uncertainty in an assessment of one or more sites (e.g., reservoir sites) where, for example, a global sensitivity analysis technique or techniques may be utilized where results thereof may be accompanied by confidence intervals. As an example, factors may be ranked with respect to influence (e.g., consider a factor being influential or noninfluential). As an example, a ranking process for sites may be improved through a reduction in uncertainty, which may be achieved, for example, by excluding noninfluential factors. In such an example, noninfluential factors may be identified using one or more techniques and, for example, excluded in a subsequent iteration of ranking of sites. As an example, a framework may provide for selecting an index technique for global sensitivity analysis based on determining whether factors are dependent or independent, which may depend on selection of factors. For example, for one set of factors, a Sobol' indices technique may be appropriate; whereas, for another set of factors, a Kucherenko indices technique may be appropriate. In such an example, the sets of factors may be for the same sites or, for example, different sites.

Below, various examples of systems, frameworks, components, methods, etc., are described that may be utilized in one or more site related operations, workflows, etc. (e.g., consider reservoir site related for purposes of carbon storage, etc.).

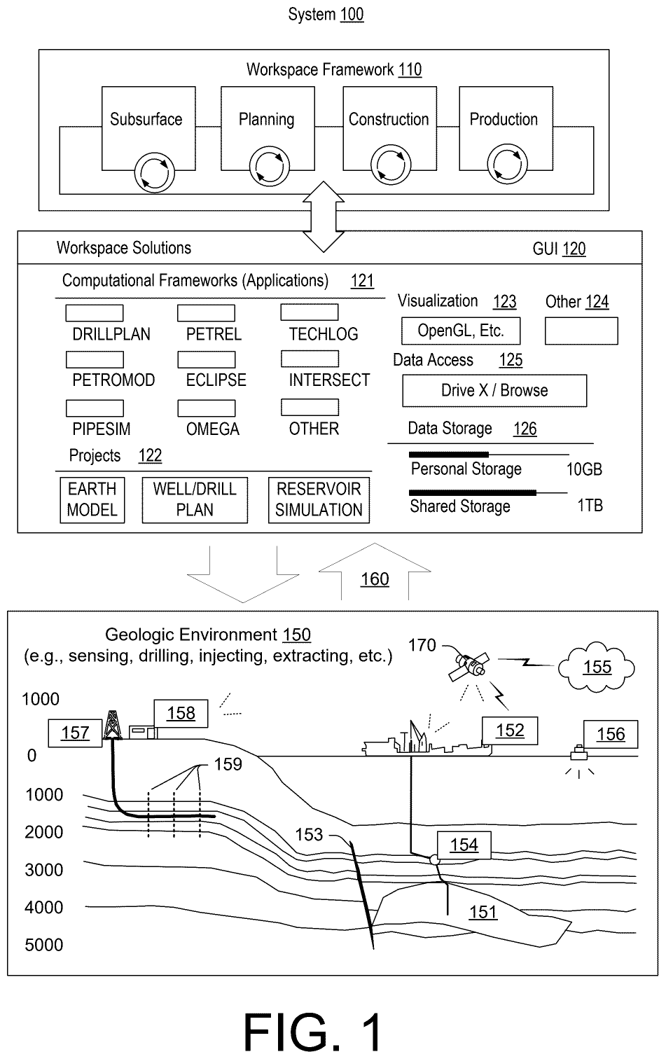

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite 170 in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As an example, a system may include a computational environment that can include various features of the DELFI environment (SLB, Houston, Texas), which may be referred to as the DELFI framework, which may be a framework of frameworks. As an example, the DELFI framework can include various other frameworks, which can include, for example, one or more types of models (e.g., simulation models, etc.). Some examples of frameworks can include the DRILLPLAN, PETREL, TECHLOG, PIPESIM, ECLIPSE, INTERSECT, VISAGE, MANGROVE, OMEGA and PETROMOD frameworks (SLB, Houston, Texas).

As an example, a system may include features of a simulation framework that provides components that allow for optimization of exploration and development operations (e.g., “E&P” operations). A framework may include seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of simulating a geologic environment, decision making, operational control, etc.).

As an example, a system may include add-ons or plug-ins that operate according to specifications of a framework environment. As an example, various components may be implemented as add-ons (or plug-ins) that conform to and operate according to specifications of a framework environment (e.g., according to application programming interface (API) specifications, etc.).

The aforementioned DELFI environment is a secure, cognitive, cloud-based collaborative environment that integrates data and workflows with digital technologies, such as artificial intelligence and machine learning. As an example, such an environment can provide for operations that involve one or more computational frameworks. For example, various types of computational frameworks may be utilized within an environment such as a drilling plan framework, a seismic-to-simulation framework, a measurements framework, a mechanical earth modeling (MEM) framework, an exploration risk, resource, and value assessment framework, a reservoir simulation framework, a surface facilities framework, a stimulation framework, etc. As an example, one or more methods may be implemented at least in part via a framework (e.g., a computational framework) and/or an environment (e.g., a computational environment).

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks that may be part of a DELFI environment.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can provide for implementing various tasks in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (chemical EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUls, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a platform, such as, for example, the LUMI platform (SLB, Houston, Texas) may be utilized. The LUMI platform includes features that provide for artificial intelligence solutions as may be integrated with data management capabilities. The LUMI platform provides for flexible deployment options and an open, secure, and modular architecture, for example, to empower data-driven decision-making. The LUMI platform is operable with the DELFI environment and, hence, one or more of various frameworks. While various platforms, environments, frameworks, libraries, etc., are mentioned, a framework may be operable in an agnostic manner, for example, to be compatible with one or more other platforms, environments, frameworks, libraries, technologies, etc.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, a visualization process can implement one or more of various features that can be suitable for one or more web applications. For example, a template may involve use of the JAVASCRIPT object notation format (JSON) and/or one or more other languages/formats. As an example, a framework may include one or more converters. For example, consider a JSON to PYTHON converter and/or a PYTHON to JSON converter. Such a converter may provide for interoperability, integration of code from one or more sources, etc.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.). As an example, a visualization framework such as the OpenGL framework (The Khronos Group, Inc., Beaverton, Oregon) may be utilized for visualizations. The OpenGL framework provides a cross-language, cross-platform application programming interface for rendering 2D and 3D vector graphics where the API may be used to interact with a graphics processing unit (or units), to achieve hardware-accelerated rendering. As an example, the VULKAN framework (The Khronos Group, Inc., Beaverton, Oregon) may be utilized for visualizations. In various instances, one or more graphics processing units (GPUs) may be utilized for visualizations and/or computing.

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 ms. Given a speed of sound in a medium or media, a sample rate may be converted to an approximate distance. For example, the speed of sound in rock may be on the order of around 5 km per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator, etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO2 operations, etc. The MANGROVE simulator provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

As an example, the KINETIX framework (SLB, Houston, Texas) can provide for analyses from 1D logs and simple geometric completions to 3D mechanical and petrophysical models coupled with the INTERSECT framework high-resolution reservoir simulator and VISAGE framework finite-element geomechanics simulator. The KINETIX framework can provide automated parallel processing using cloud platform resources and can provide for rapid assessment of well spacing, completion, and treatment design choices, enabling exploration of many scenarios in a relatively rapid manner (e.g., via provisioning of cloud platform resources). The KINETIX framework may be operatively coupled to the MANGROVE simulator (SLB, Houston, Texas), which can provide for optimization of stimulation design (e.g., stimulation treatment operations such as hydraulic fracturing) in a reservoir-centric environment.

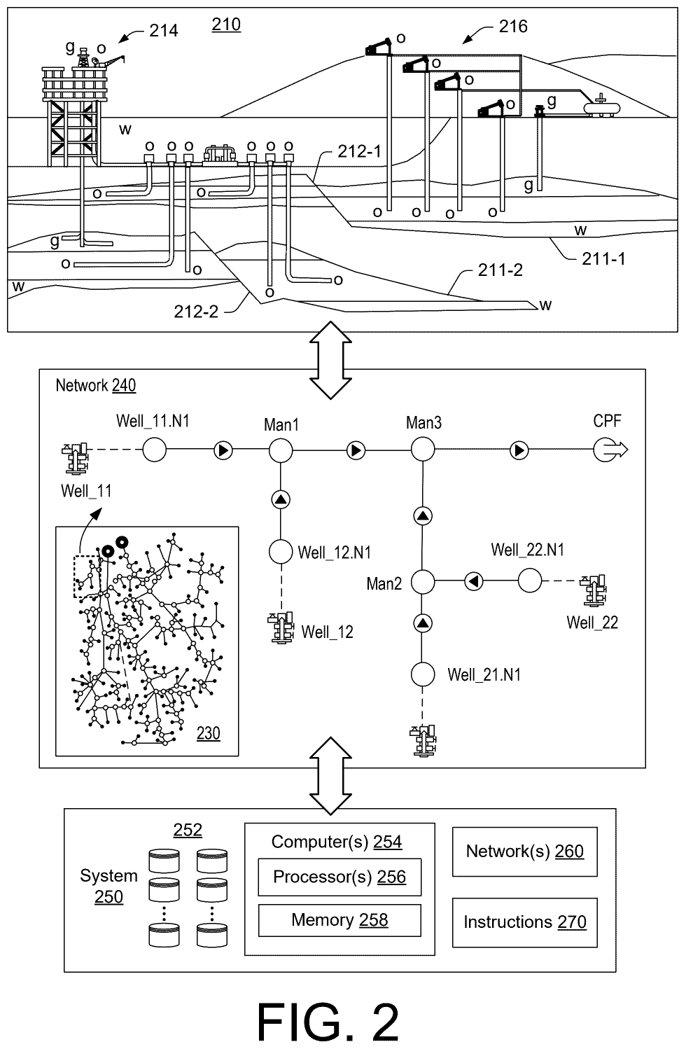

FIG. 2 shows an example of a geologic environment 210 that includes reservoirs 211-1 and 211-2, which may be faulted by faults 212-1 and 212-2, an example of a network of equipment 230, an enlarged view of a portion of the network of equipment 230, referred to as network 240, and an example of a system 250. FIG. 2 shows some examples of offshore equipment 214 for oil and gas operations related to the reservoir 211-2 and onshore equipment 216 for oil and gas operations related to the reservoir 211-1.

In FIG. 2, the network 240 can be an example of a relatively small production system network. As shown, the network 240 forms somewhat of a tree like structure where flowlines represent branches (e.g., segments) and junctions represent nodes. As shown in FIG. 2, the network 240 provides for transportation of oil and gas fluids from well locations along flowlines interconnected at junctions with final delivery at a central processing facility.

In the example of FIG. 2, various portions of the network 240 may include conduit. For example, consider a perspective view of a geologic environment that includes two conduits which may be a conduit to Man1 and a conduit to Man3 in the network 240.

As shown in FIG. 2, the example system 250 includes one or more information storage devices 252, one or more computers 254, one or more networks 260 and instructions 270 (e.g., organized as one or more sets of instructions). As to the one or more computers 254, each computer may include one or more processors (e.g., or processing cores) 256 and memory 258 for storing the instructions 270 (e.g., one or more sets of instructions), for example, executable by at least one of the one or more processors. As an example, a computer may include one or more network interfaces (e.g., wired or wireless), one or more graphics cards, a display interface (e.g., wired or wireless), etc. As an example, imagery such as surface imagery (e.g., satellite, geological, geophysical, etc.) may be stored, processed, communicated, etc. As an example, data may include SAR data, GPS data, etc. and may be stored, for example, in one or more of the storage devices 252. As an example, information that may be stored in one or more of the storage devices 252 may include information about equipment, location of equipment, orientation of equipment, fluid characteristics, etc.

As an example, the instructions 270 can include instructions (e.g., stored in the memory 258) executable by at least one of the one or more processors 256 to instruct the system 250 to perform various actions. As an example, the system 250 may be configured such that the instructions 270 provide for establishing a framework, for example, that can perform network modeling (see, e.g., the PIPESIM framework of the example of FIG. 1, etc.) and/or one or more other types of modeling. As an example, one or more methods, techniques, etc. may be performed using one or more sets of instructions, which may be, for example, the instructions 270 of FIG. 2.

As an example, a model may be made that models a geologic environment in combination with equipment, wells, etc. For example, a model may be a flow simulation model for use by a simulator to simulate flow in an oil, gas or oil and gas production system. Such a flow simulation model may include equations, for example, to model multiphase flow from a reservoir to a wellhead, from a wellhead to a reservoir, etc. A flow simulation model may also include equations that account for flowline and surface facility performance, for example, to perform a comprehensive production system analysis.

As an example, a flow simulation model may be a network model that includes various sub-networks specified using nodes, segments, branches, etc. As an example, a flow simulation model may be specified in a manner that provides for modeling of branched segments, multilateral segments, complex completions, intelligent downhole controls, etc. As an example, one or more portions of a production network (e.g., optionally sub-networks, etc.) or a group of signal components and/or controllers may be modeled as sub-models.

As an example, a system may provide for transportation of oil and gas fluids from well locations to processing facilities and may represent a substantial investment in infrastructure with both economic and environmental impact. Simulation of such a system, which may include hundreds or thousands of flow lines and production equipment interconnected at junctions to form a network, can involve multiphase flow science and, for example, use of engineering and mathematical techniques for large systems of equations.

As an example, a flow simulation model may include equations for performing nodal analysis, pressure-volume-temperature (PVT) analysis, gas lift analysis, erosion analysis, corrosion analysis, production analysis, injection analysis, etc. In such an example, one or more analyses may be based, in part, on a simulation of flow in a modeled network.

As to nodal analysis, it may provide for evaluation of well performance, for making decisions as to completions, etc. A nodal analysis may provide for an understanding of behavior of a system and optionally sensitivity of a system (e.g., production, injection, production and injection). For example, a system variable may be selected for investigation and a sensitivity analysis performed. Such an analysis may include plotting inflow and outflow of fluid at a nodal point or nodal points in the system, which may indicate where certain opportunities exist (e.g., for injection, for production, etc.).

A modeling framework may include instructions (e.g., processor-executable instructions) to facilitate generation of a flow simulation model. For example, instructions may provide for modeling completions for vertical wells, completions for horizontal wells, completions for fractured wells, etc. A modeling framework may include instructions for particular types of equations, for example, black-oil equations, EoSs, etc. A modeling framework may include instructions for artificial lift, for example, to model fluid injection, fluid pumping, etc. As an example, consider a set of instructions (e.g., a component) that includes features for modeling one or more electric submersible pumps (ESPs) (e.g., based in part on pump performance curves, motors, cables, etc.).

As an example, an analysis using a flow simulation model may be a network analysis to: identify production bottlenecks and constraints; assess benefits of new wells, additional pipelines, compression systems, etc.; calculate deliverability from field gathering systems; predict pressure and temperature profiles through flow paths; or plan full-field development.

As an example, a flow simulation model may provide for analyses with respect to future times, for example, to allow for optimization of production equipment, injection equipment, etc. As an example, consider an optimal time-based and conditional-event logic representation for daily field development operations that can be used to evaluate drilling of new developmental wells, installing additional processing facilities over time, choke-adjusted wells to meet production and operating limits, shutting in of depleting wells as reservoir conditions decline, etc.

As to equations, sets of conservation equations for mass momentum and energy describing single, two or three phase flow (e.g., according to one or more of a LEDAFLOW (Kongsberg Oil & Gas Technologies AS, Sandvika, Norway), OLGA model (SLB, Houston, Texas), TUFFP unified mechanistic models (Tulsa University Fluid Flow Projects, Tulsa, Oklahoma), etc.).

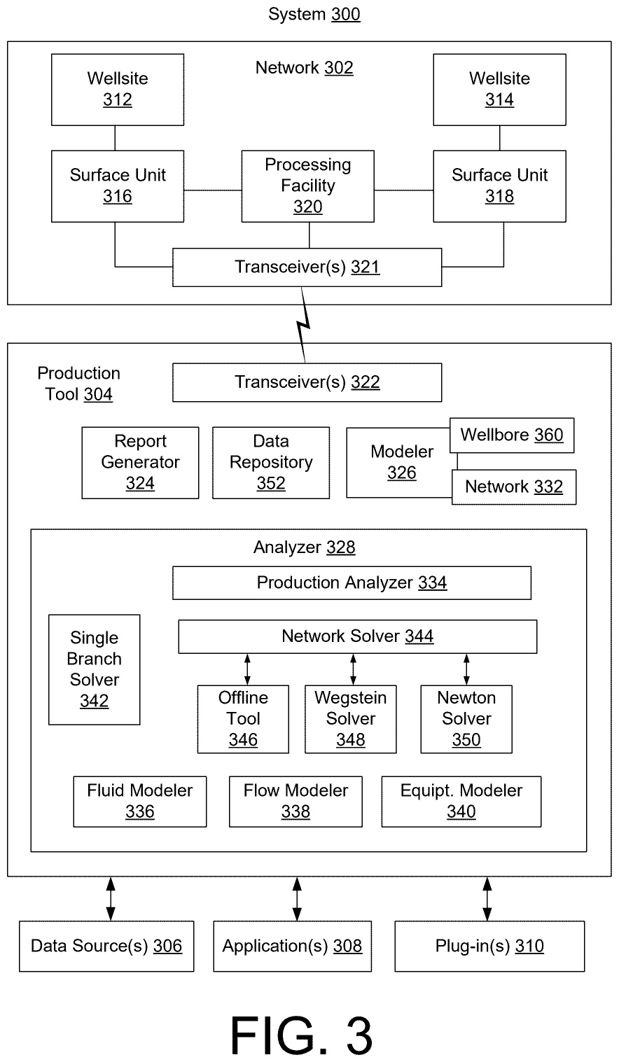

FIG. 3 shows an example of a schematic diagram of a production system 300 for performing oilfield production operations. As shown in the example of FIG. 3, the production system 300 can include an oilfield network 302, an oilfield production tool 304, one or more data sources 306, one or more oilfield application(s) 308, and one or more plug-in(s) 310. As an example, the oilfield network 302 can be an interconnection of pipes (e.g., conduits) that connects wellsites (e.g., a wellsite 1 312, a wellsite n 314, etc.) to a processing facility 320. A pipe in the oilfield network 302 may be connected to a processing facility (e.g., a processing facility 320), a wellsite (e.g., the wellsite 1 312, the wellsite n 314, etc.), and/or a junction in which pipes are connected. As an example, flow rate of fluid and/or gas into pipes may be adjustable; thus, certain pipes in the oilfield network 302 may be choked or closed so as to not allow fluid and/or gas through the pipe. A pipe may be considered open (e.g., optionally choked) when the pipe allows for flow of fluid and/or gas. As to a choke, choking may allow for adjusting one or more characteristics of a piece of flow equipment (e.g., a cross-sectional flow area, etc.), for example, for adjusting to fully open flow, for adjusting to choked flow and/or for adjusting to no flow (e.g., closed).

The oilfield network 302 may be a gathering network and/or an injection network. A gathering network may be an oilfield network used to obtain hydrocarbons from a wellsite (e.g., the wellsite 1 312, the wellsite n 314, etc.). In a gathering network, hydrocarbons may flow from the wellsites to the processing facility 320. An injection network may be an oilfield network used to inject the wellsites with injection substances, such as water, carbon dioxide, and other chemicals that may be injected into the wellsites. In an injection network, the flow of the injection substance may flow towards the wellsite (e.g., toward the wellsite 1 312, the wellsite n 314, etc.).

The oilfield network 302 may also include one or more surface units (e.g., a surface unit 1 316, a surface unit n 318, etc.), for example, a surface unit for each wellsite. Such surface units may include functionality to collect data from sensors. Such sensors may include sensors for measuring flow rate, water cut, gas lift rate, pressure, and/or other such variables related to measuring and monitoring hydrocarbon production. As shown, the oilfield network 302 can include one or more transceivers 321, for example, to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the oilfield production tool 304 may be connected to the oilfield network 302. The oilfield production tool 304 may be a simulator (e.g., a simulation framework) or a plug-in for a simulator (e.g., or other application(s)). The oilfield production tool 304 may include one or more transceivers 322, a report generator 324, an oilfield modeler 326, and an oilfield analyzer 328. As an example, the one or more transceivers 322 may be configured to receive information, to transmit information, to receive information and transmit information, etc. As an example, information may be received and/or transmitted via wire and/or wirelessly. As an example, information may be received and/or transmitted via a communications network such as, for example, the Internet, the cloud, a cellular network, a satellite network, etc.

As an example, the report generator 324 can include functionality to produce graphical and textual reports. Such reports may show historical oilfield data, production models, production results, sensor data, aggregated oilfield data, or any other such type of data.

As an example, the data repository 352 may be a storage unit and/or device (e.g., a file system, database, collection of tables, or any other storage mechanism) for storing data, such as the production results, sensor data, aggregated oilfield data, or any other such type of data. As an example, the data repository 352 may include multiple different storage units and/or hardware devices. Such multiple different storage units and/or devices may or may not be of the same type or located at the same physical site. As an example, the data repository 352, or a portion thereof, may be secured via one or more security protocols, whether physical, algorithmic or a combination thereof (e.g., data encryption, secure device access, secure communication, etc.).

In the example of FIG. 3, the oilfield modeler 326 can include functionality to create a model of a wellbore and an oilfield network where the wellbore is in fluid communication with a reservoir. As shown, the oilfield modeler 326 includes a wellbore modeler 360 and a network modeler 332. As an example, the wellbore modeler 360 can allow a user to create a graphical wellbore model or single branch model. As an example, a wellbore model can define operating parameters (e.g., actual, theoretical, etc.) of a wellbore (e.g., pressure, flow rate, etc.). As an example, a single branch model may define operating parameters of a single branch in an oilfield network.

As to the network modeler 332, it may allow a user to create a graphical network model that combines wellbore models and/or single branch models. As an example, the network modeler 328 and/or wellbore modeler 360 may model pipes in the oilfield network 302 as branches of the oilfield network 302 (e.g., optionally as one or more segments, optionally with one or more nodes, etc.). In such an example, each branch may be connected to a wellsite or a junction. A junction may be defined as a group of two or more pipes that intersect at a particular location (e.g., a junction may be a node or a type of node).

As an example, a modeled oilfield network may be formed as a combination of sub-networks. In such an example, a sub-network may be defined as a portion of an oilfield network. For example, a sub-network may be connected to the oilfield network 302 using at least one branch. Sub-networks may be a group of connected wellsites, branches, and junctions. As an example, sub-networks may be disjoint (e.g., branches and wellsites in one sub-network may not exist in another sub-network).

As an example, the oilfield analyzer 328 can include functionality to analyze the oilfield network 302 and generate a production result for the oilfield network 302. As shown in the example of FIG. 3, the oilfield analyzer 328 may include one or more of the following: a production analyzer 334, a fluid modeler 336, a flow modeler 338, an equipment modeler 340, a single branch solver 342, a network solver 344, a Wegstein solver 348, a Newton solver 350, and an offline tool 346.

As an example, the production analyzer 334 can include functionality to receive a workflow request and interact with the single branch solver 342 and/or the network solver 344 based on particular aspects of the workflow. For example, the workflow may include a nodal analysis to analyze a wellsite or junction of branches, pressure and temperature profile, model calibration, gas lift design, gas lift optimization, network analysis, and other such workflows.

As an example, the fluid modeler 336 can include functionality to calculate fluid properties (e.g., phases present, densities, viscosities, etc.) using one or more compositional and/or black-oil fluid models, which can involve using one or more EoSs. The fluid modeler 336 may include functionality to model oil, gas, water, hydrate, wax, asphaltene phases, etc. As an example, the flow modeler 338 can include functionality to calculate pressure drop in pipes (e.g., pipes, tubing, etc.) using industry standard multiphase flow correlations. As an example, the equipment modeler 340 can include functionality to calculate pressure changes in equipment pieces (e.g., chokes, pumps, compressors, etc.). As an example, one or more substances may be introduced via a network for purposes of managing asphaltenes, waxes, etc. As an example, a modeler may include functionality to model interaction between one or more substances and fluid (e.g., including material present in the fluid).

As an example, the single branch solver 342 may include functionality to calculate the flow and pressure drop in a wellbore or a single flowline branch given various inputs.

As an example, the network solver 344 can includes functionality calculate a flow rate and pressure drop throughout the oilfield network 302. The network solver 344 may be configured to connect to the offline tool 346, the Wegstein solver 348, and the Newton solver 350. As an example, alternatively or additionally, one or more other solvers may be provided, for example, consider a sequential linear programming solver (SLP), a sequential quadratic programming solver (SQP), etc. As an example, a solver may be part of the production tool 304, part of the analyzer 328 of the production tool 304, part of a system to which the production tool 304 may be operatively coupled, etc.

As an example, the offline tool 346 may include a wells offline tool and a branches offline tool. A wells offline tool may include functionality to generate a production model using the single branch solver 342 for a wellsite or branch. A branches offline tool may include functionality to generate a production model for a sub-network using the production model for a wellsite, a single branch, or a sub-network of the sub-network.

As an example, a production model may be capable of providing a description of a wellsite with respect to various operational conditions. A production model may include one or more production functions that may be combined, for example, where each production function may be a function of variables related to the production of hydrocarbons. For example, a production function may be a function of flow rate and/or pressure. Further, a production function may account for environmental conditions related to a sub-network of the oilfield network 302, such as changes in elevation (e.g., for gravity head, pressure, etc.), diameters of pipes, combination of pipes, and changes in pressure resulting from joining pipes. A production model may provide estimates of flow rate for a wellsite or sub-network of an oilfield network.

As an example, one or more separate production functions may exist that can account for changes in one or more values of an operational condition. An operational condition may identify a property of hydrocarbons or injection substance. For example, an operational condition may include a watercut (WC), reservoir pressure, gas lift rate, etc. Other operational conditions, variables, environmental conditions may be considered.

As to the network solver 344, in the example of FIG. 3, it is shown as being connected to the Wegstein solver 348 and/or the Newton solver 350. The Wegstein solver 348 and the Newton solver 350 include functionality to combine a production model for several sub-networks to create a production result that may be used to plan an oilfield network, optimize flow rates of wellsites in an oilfield network, and/or identify and address faulty components within an oilfield network. The Wegstein solver 348 can use an iterative method with Wegstein acceleration.

An oilfield network may be solved by identifying pressure drop (e.g., pressure differential), for example, through use of momentum equations. As an example, an equation for pressure differential may account for factors such as fluid potential energy (e.g., hydrostatic pressure), friction (e.g., shear stress between conduit wall and fluid), and acceleration (e.g., change in fluid velocity). As an example, an equation may be expressed in terms of static reservoir pressure, a flowing bottomhole pressure and flowrate. As an example, equations may account for vertical, horizontal or angled arrangements of equipment. Various examples of equations may be found in a dynamic multiphase flow simulator such as the simulator of the OLGA simulation framework (SLB, Houston, TX), which may be implemented for design and diagnostic analysis of oil and gas production systems. As an example, a simulation framework may include one or more sets of instructions for building a model; for fluid and multiphase flow modeling; for reservoir, well and completion modeling; for field equipment modeling; and for operations (e.g., artificial lift, gas lift, wax prediction, nodal analysis, network analysis, field planning, multi-well analysis, etc.).

As an example, a system may implement equations that include dynamic conservation equations for momentum, mass and energy. As an example, pressure and momentum can be solved implicitly and simultaneously and, for example, conservation of mass and energy (e.g., temperature) may be solved in succeeding separate stages.

As an example, an equation for pressure differential can account for factors such as fluid potential energy (e.g., hydrostatic pressure), friction (e.g., shear stress between conduit wall and fluid), and acceleration (e.g., change in fluid velocity). In addition, as mentioned, equations can be used to take into account dynamic aspects. For example, equations can account for time and forces to accelerate and decelerate fluid (e.g., and objects) inserted into multiphase flow (e.g., consider pigs, etc.). As an example, an approach may consider the time it takes to conserve mass and energy (e.g., an amount of time it takes to drain a system, pipeline or vessel). As an example, an approach may consider ramp-up time for production, for example, from one production rate to another production rate, etc. As an example, an approach may consider time it takes before a first condensate appears at an outlet of a production network during startup, etc.

As an example, an equation for a pressure differential (e.g., ΔP) may be rearranged to solve for flow rate (e.g., Q), where the equation may include the Reynolds number (e.g., Re, a dimensionless ratio of inertial to viscous forces), one or more friction factors (e.g., which may depend on flow regime), etc.

Through use of equations for flow into and out of a branch and equating to zero, a linear matrix in unknown pressures may be obtained. As an example, fixed flow branches (i.e., branches in which the flow does not change) may be solved directly for the node pressures.

As an example, a method can include defining variables and residual equations as well as branches in an oilfield network that may include a number of equipment items. As an example, a branch may be divided into sub-branches with each sub-branch containing a single equipment item. As an example, a new node may be used to join each pair of sub-branches. In such an example, primary Newton-Raphson variables can include a flow (Q_{ib}) in each sub-branch in the network and a pressure Pin at each node in the network. In this example, temperature (or enthalpy) and composition may be treated as secondary variables.

As an example, residual equations may include a branch residual, an internal node residual, and a boundary condition. In such an example, a branch residual for a sub-branch relates the branch flow to the pressure at the branch inlet node and the pressure at the outlet node. As an example, internal node residuals can define where total flow into a node is equal to total flow out of the node.

As an example, determining an initial solution may be performed using a production model where for each subsequent iteration, a Jacobian matrix is calculated. The values of the Jacobian matrix may be used to solve a Jacobian equation for the Newton-Raphson update. To solve the Jacobian equation, one or more types of matrix solvers may be used.

In the example of FIG. 3, the one or more data sources 306 include one or more types of repositories for data. For example, the one or more data sources 306 may be Internet sources, sources from a company having ties to the oilfield network 302, or any other location in which data may be obtained. The data may include historical data, data collected from other oilfield networks, data collected from the oilfield network being modeled, data describing environmental or operational conditions.

In the example of FIG. 3, the one or more oilfield applications 308 may be applications related to the production of hydrocarbons. The one or more oilfield applications 308 may include functionality to evaluate a formation, manage drilling operations, evaluate seismic data, evaluate workflows in the oilfield, perform simulations, or perform any other oilfield related function. In the example of FIG. 3, the one or more plug-ins 310 may allow integration with packages such as, for example, a TUFPP model, an Infochem Multiflash model (Infochem Computer Services Ltd., London, UK), an equipment model, etc. (e.g., consider one or more simulators like HYSYS (AspenTech, Burlington, Massachusetts), UNISIM (Honeywell, Morristown, New Jersey), etc.).

While the example of FIG. 3 shows the oilfield production tool 304 as a separate component from the oilfield network 302, the oilfield production tool 304 may alternatively be part of the oilfield network 302. For example, the oilfield production tool 304 may be located at one of the wellsites (e.g., the wellsite 1 312, the wellsite n 314, etc.), at the processing facility 320, or any other location in the oilfield network 302. As another example, the oilfield production tool 304 may exist separate from the oilfield network 302, such as when the oilfield production tool 304 is used to plan the oilfield network.

Various types of numerical solution schemes may be characterized as being explicit or implicit. For example, when a direct computation of dependent variables can be made in terms of known quantities, a scheme may be characterized as explicit. Whereas, when dependent variables are defined by coupled sets of equations, and either a matrix or iterative technique is implemented to obtain a solution, a scheme may be characterized as implicit.

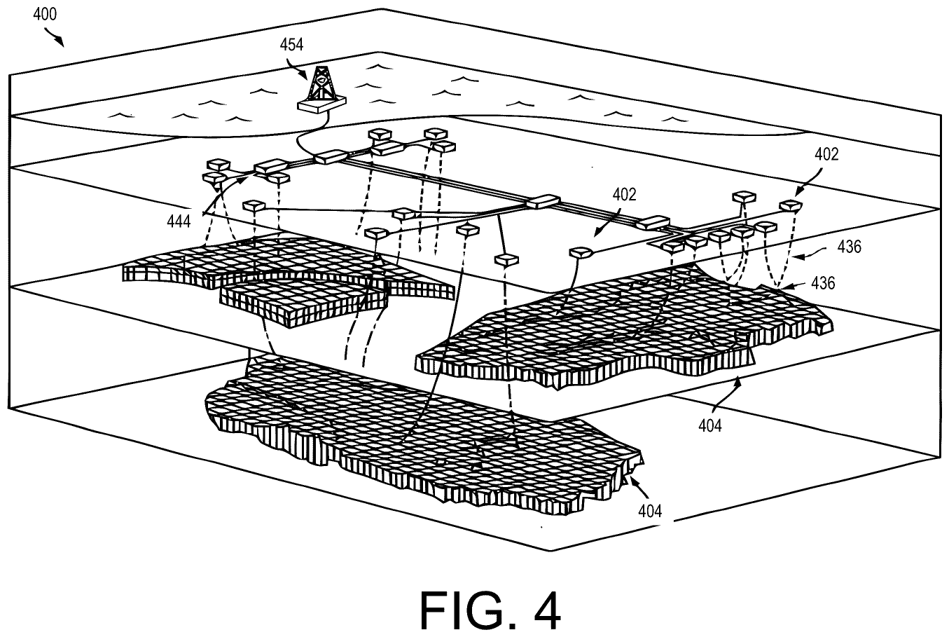

FIG. 4 shows an example of a geologic environment 400 and a system of various types of equipment. As shown, the geologic environment 400 includes a plurality of wellsites 402 operatively connected to a processing facility 454 (e.g., offshore or on-shore). In the example of FIG. 4, individual wellsites 402 can include equipment that can form individual wellbores 436. Such wellbores can extend through subterranean formations 406 including one or more reservoirs 404. Such reservoirs 404 can include fluids, such as hydrocarbons. As an example, wellsites can draw fluid from one or more reservoirs and pass them to one or more processing facilities via one or more surface networks 444. As an example, a surface network can include tubing and control mechanisms for controlling flow of fluids from a wellsite to a processing facility. As an example, the geologic environment 400 may provide for production and/or injection of material (e.g., to and/or from one or more reservoirs).

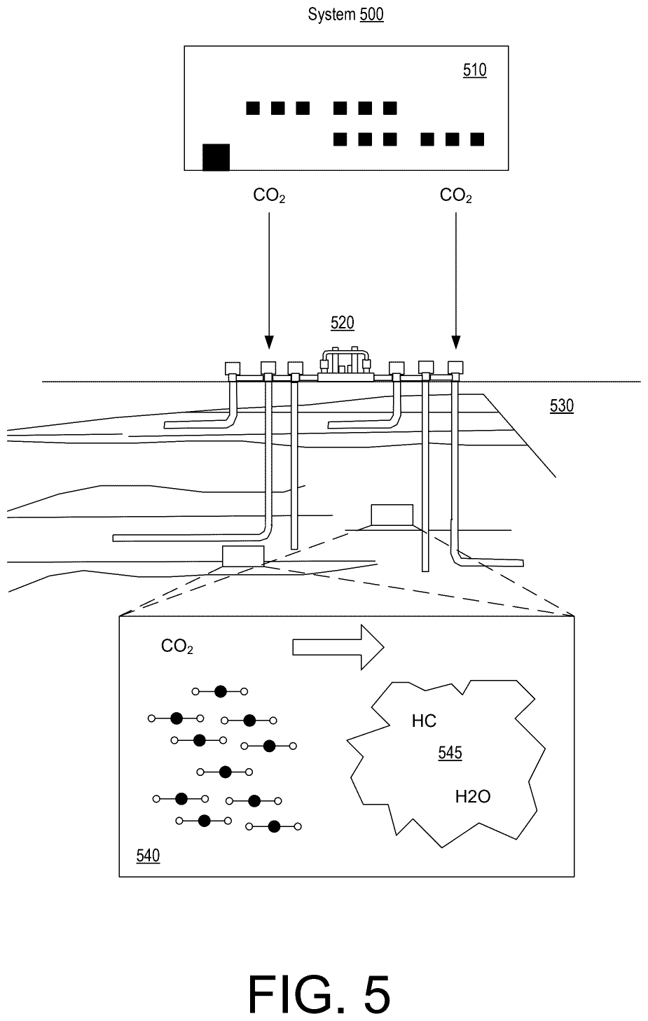

FIG. 5 shows an example of a system 500 that includes a facility 510 that generates CO2 and a surface network 520 with wells that extend into one or more subsurface regions 530 where the CO2 generated by the facility 510 can be injected into at least one of the one or more subsurface regions 530 to store the CO2. As shown in a graphic 540, CO2 can enter rock 545, which can include hydrocarbons (HC) and/or water (H2O). In such an example, mixing may occur such that the rock 545 becomes saturated with fluid that includes CO2 and, for example, one or more other components (e.g., HC and/or H2O). As an example, the facility 510 may provide for acquisition of data. In such an example, the data may be assessed by a framework that can generate control instructions for one or more processes, which can include processes of the facility 510 (e.g., consider carbon generating processes), processes controllable via the surface network 520, etc. As an example, such a framework may provide for making assessments with respect to one or more other sites where similar processes may be occurring or have occurred. In such an example, a framework may provide for dynamic control of one or more processes (e.g., chemical, fluid, production, injection, etc.) at one or more sites. As an example, a framework may receive streaming data from one or more sites, which may be in one or more stages, such as, for example, an exploration stage, a development stage, a utilization stage, etc.

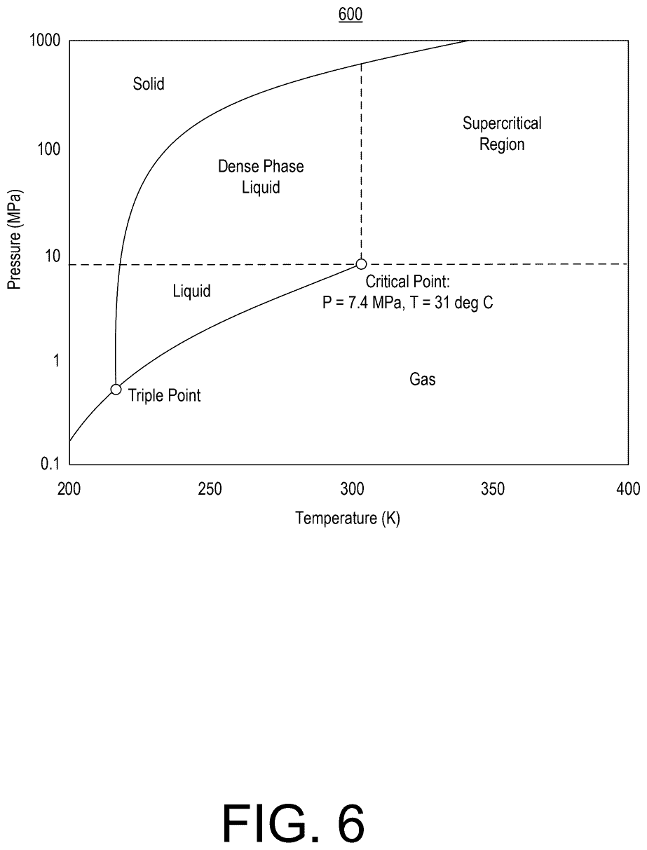

FIG. 6 shows an example of a pressure and temperature phase diagram 600 for CO2. As shown, regions can include gas, liquid, solid, dense phase liquid, and a supercritical region that extends to pressures and temperatures above the critical point, which can be approximately at a pressure of 7.4 MPa and approximately at a temperature of 31 degC. As an example, field operations may be controlled at one or more sites using a framework (e.g., a single instance or multiple instances) where, for example, pressure and/or temperature may be controlled.

CO2 usually behaves as a gas in air at standard temperature and pressure (STP), or as a solid called dry ice when cooled and/or pressurized sufficiently. If temperature and pressure are both increased from STP to be at or above the critical point for CO2, the CO2 can adopt properties between a gas and a liquid. More specifically, CO2 can behave as a supercritical fluid above its critical temperature (e.g., 31 degC) and critical pressure (e.g., 7.4 MPa or 74 bar). Supercritical CO2 can expand to fill its “container” like a gas but with a density like that of a liquid. Thus, supercritical CO2 can behave quite different than subcritical CO2. And, where CO2 mixes with one or more other components, its behavior (e.g., as exhibited by physical properties) can be challenging to predict.

As an example, phase behavior of CO2 may be modeled using one or more equations of state (EoSs). As an example, CO2 as a fluid may be modeled alone or in a mixture. For example, consider CO2 and water as a mixture. In various examples, once CO2 is modeled or characterized, whether alone or as a mixture, it may optionally be combined with one or more additional components to form a final mixture that is suitable for use in one or more workflows. In such an approach, one or more mixing models and/or rules may be employed. As an example, multiple techniques may be employed where an ensemble approach can involve taking one or more types of averages (e.g., arithmetic, harmonic, etc.) to arrive at acceptable values. As explained, a framework may provide for control of field operations such that CO2 may be controlled, alone and/or with one or more other materials. In such an example, the framework may provide for dynamic control, for example, response to receipt of sensor data, which may include sensor data from one or more field sites.

While a phase diagram is shown in FIG. 6 as to CO2, phase diagrams can be utilized for various aspects of modeling, operations, etc. For example, phase behavior for a reservoir suitable for CO2 injection and storage may be relevant whether the reservoir is currently partially depleted, or fully depleted or hydrocarbons and/or water. As an example, a workflow may include assessing one or more existing reservoirs that are producing hydrocarbons to determine when and how CO2 injection may occur. In such an example, the workflow may include issuing control instructions for field equipment to inject CO2 and/or to generate CO2 (see, e.g., the facility 510 of FIG. 5).

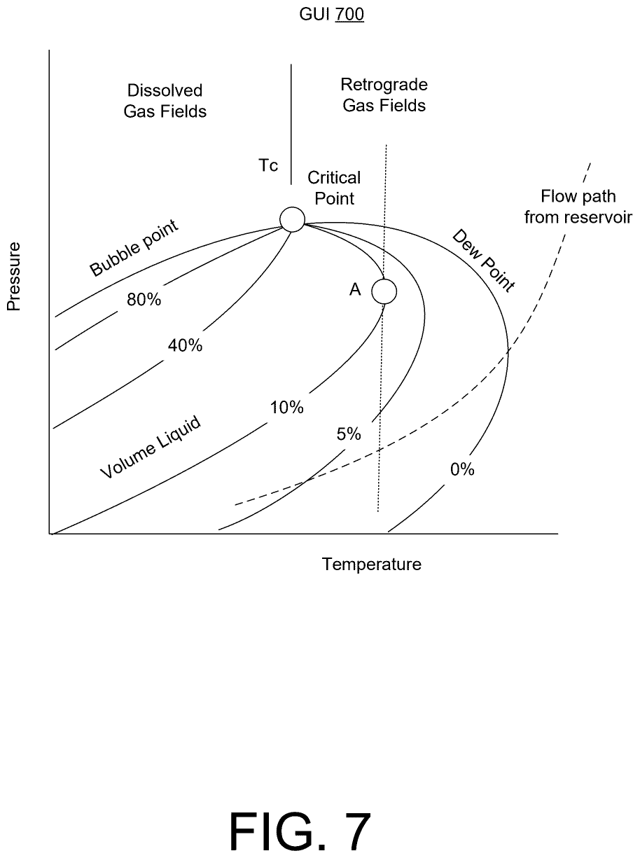

FIG. 7 shows an example of a graphical user interface 700 that includes a phase plot (e.g., a phase diagram) with respect to pressure and temperature. As shown, various types of fields may be characterized using such a phase plot (e.g., dissolved gas, retrograde, etc.). As shown, a flow path from a reservoir may be plotted on such a phase plot that can represent a wellbore where fluid is transported from a reservoir at a particular pressure and temperature to surface, which can be at a lesser pressure and temperature. As an example, such a plot can be generated from one or more samples (e.g., sample information) and/or using one or more EoSs. As an example, the graphical user interface 700 may be suitable for assessing one or more subsurface geological site for one or more purposes. As an example, such an approach may be adaptable and flexible to handle types of issues that may be germane to one or more types of applications (e.g., mineral, geothermal, nuclear, carbon, hydrocarbon, etc.). As an example, where a subsurface region may be mapped or otherwise represented in multiple dimensions, a framework may provide for generating one or more flow paths that may be related to one or more reservoir properties (e.g., pressure, temperature, material, etc.). As an example, the graphical user interface 700 may be dynamic and change responsive to receipt of actual data, synthetic data, etc., for example, to assess a possible flow path, an actual flow path, etc. In various instances, a reservoir may be dynamic in that pressure and/or temperature may change with respect to time. As an example, a framework may provide for control of field equipment in a manner that depends on pressure data and/or temperature data.

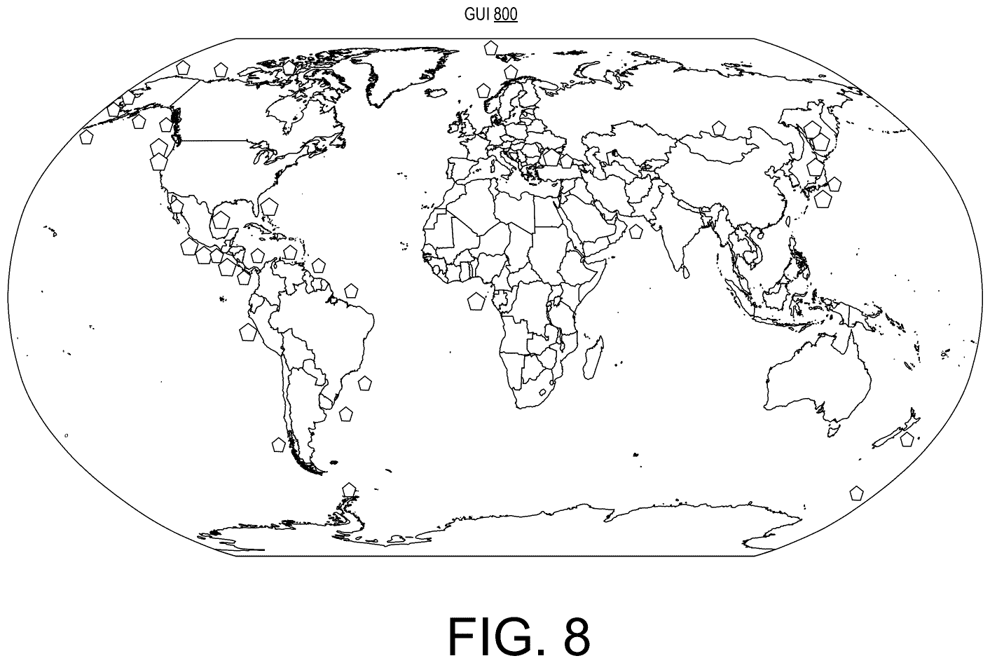

FIG. 8 shows an example of a graphical user interface 800 that includes a map where various markers may indicate whether or not a reservoir at a location may be amenable for utilization for one or more purposes (e.g., mineral, geothermal, nuclear, carbon, hydrocarbon, etc.). As an example, a framework may provide for assessing various reservoir sites and, for example, ranking various reservoir sites based at least in part on one or more criteria.

As an example, a framework may be a global sensitivity analysis framework that may provide assessing various sites, which may include, for example, carbon storage sites (e.g., for carbon storage site ranking and selection). In various instances, a site may be suitable for one or more purposes, which may include purposes with respect to time. For example, consider a hydrocarbon production site that may evolve over time due to production of hydrocarbons into a suitable site for carbon storage. In such an example, a framework may provide for dynamic simulations that can be performed as to one purpose and then as to another purpose, for example, in a back-to-back manner where a resulting state of the first purposes is utilized to simulate the second purpose.

As an example, a framework may provide for performing global sensitivity analyses as part of one or more site assessment workflows, which may include, for example, a carbon storage site ranking workflow and/or a selection workflow, for example, with possible correlations between involved site properties considered. As an example, such a framework may find particular site properties that contribute the most to ranking results variability and, for example, provide guidance for data acquisition in one or more subsequent evaluation and/or characterization phases, which may help to decrease uncertainty and risk of site ranking and selection. In such an example, properties may be assessed with respect to one or more simulators. For example, where sufficient data exist for running a particular simulator, the framework may indicate that such a simulator may be executed, which may occur automatically responsive to such a determination. In such an example, the framework may provide for provisioning computing resources (e.g., cloud platform resources, etc.) and automatic execution of a simulation or simulations. In such an example, the framework may provide for generation of additional data (e.g., synthetic data) that may provide for more accurate assessments (e.g., ranking, etc.). In instances where data may be insufficient, a framework may provide for searching one or more databases as to one or more sites that may provide suitable analog data (e.g., based on an initial ranking, etc.). In such an example, where suitable analog data are found (e.g., a physical analog from an offset site to a site of interest), the framework may provide for provisioning of computations resources and executing one or more simulators. In instances where data may be insufficient and suitable analog data are unavailable (e.g., lack of a suitable match), the framework may provide for outputting a listing of types of data, volumes of data, etc., that may be sufficient to proceed with simulation. As explained, a framework may make decisions in a dynamic manner, which may include data acquisition decisions, data search decisions, simulation decisions, etc. In such an approach, a framework may enhance its ability to assess sites and, as appropriate, provide for control of field operations at one or more sites. As an example, a framework may automatically improve site ranking in that the framework may operate in a live, online manner where it can uncover similarities and/or differences between sites and utilizes them to more accurately rank sites, find analog sites, etc.

As an example, a framework may provide for manual and/or automatic property selection. For example, a framework may provide for rendering a GUI that includes various property options that may be selected via user interaction with the GUI. As an example, a framework may provide for use of a default set of properties and/or for use of a set of properties that may be tailored based on data available for one or more sites. For example, if a site that has a limited data for a set of particular properties, then those particular properties may dictate property selection for sake of comparison of that site to one or more other sites. As an example, a framework may determine what sites have properties in common such that those sites may be compared. In such an example, a framework may provide for rendering of a GUI with a listing of the properties in common where a user may interact with the GUI to select properties from amongst the properties in common.

In various instances, for a site, there may be relatively weak correlation between site properties such that the site may be characterized as having no correlation between its available site properties (e.g., data for the site properties). As to a determination as to whether correlation is weak or strong, one or more thresholds may be utilized. For example, a threshold may be determined based on knowledge of how strong correlations may be where site properties are correlated for a site.

As to a correlation coefficient, consider a relatively simple example where the sample correlation coefficient, R, is a measure of closeness of association of points in a scatter plot to a linear regression line based on those points. In such an example, possible values of the correlation coefficient may range from −1 to +1, with −1 indicating a perfectly linear negative (inverse) correlation (sloping downward) and +1 indicating a perfectly linear positive correlation (sloping upward). In such an example, a correlation coefficient close to 0 suggests little, if any, correlation. As an example, R values from 0.4 to 0.6, whether negative or positive, may indicate moderate association; whereas, R values from 0.2 to 0.4, whether negative or positive, may indicate weak association and R values from −0.2 to +0.2 may indicate very weak or no association. As mentioned, if a best expected correlation is 0.6, then a threshold for no correlation may be 0.2; whereas, if a best expected correlation is 0.99, then a threshold for no correlation may be greater than 0.2. In such an approach, decisions may be made as to correlation versus no correlation in a relative manner. In such an approach, a framework may provide for decision making as to whether or not properties for a site are correlated or not.

For linear analysis, R may depend on covariance (e.g., how far each observed pair is from respective means) and sample variances. For non-linear analysis, a more complicated approach may be taken to assessing correlation. Whether linear and/or non-linear, other factors may be taken into account such as, for example, outliers.

As an example, a framework may provide for assessing sensitivity globally amongst properties for a site in a manner that depends on whether or not the properties are correlated or not. For example, when a framework determines that there is insufficient correlation between site properties (e.g., no correlation per a threshold, etc.), the framework may use the Sobol' indices technique may be employed for global sensitivity analysis; otherwise, the framework may use the Kucherenko indices technique (e.g., sufficient correlation between site properties per a threshold, etc.).

As an example, a framework may implement a Sobol' technique and/or a Kucherenko technique based at least in part on an assessment of correlation between properties. These two techniques explore an entire input space and rely on variance decomposition, while the Kucherenko indices technique further supports correlations by conditionally sampling with Gaussian copula. A Gaussian copula model is based on copula functions where copula is a distribution over a unit cube (e.g., [0,1]^{d}), which can be constructed from a multivariate normal distribution over [symbol] ^{d} by using a probability integral transform.

A variance-based sensitivity analysis (e.g., Sobol' indices technique) is a form of global sensitivity analysis. Working within a probabilistic framework, it decomposes the variance of the output of the model or system into fractions which can be attributed to inputs or sets of inputs. For example, given a model with two inputs and one output, it may be that 70% of the output variance is caused by the variance in the first input, 20% by the variance in the second, and 10% due to interactions between the two. Such percentages can be directly interpreted as measures of sensitivity. Variance-based measures of sensitivity may be helpful as they measure sensitivity across an entire input space (e.g., a global technique). Such an approach may deal with non-linear responses and may provide for measuring the effect of interactions in non-additive systems.

As explained, the Sobol' indices technique may be utilized where site parameters are not sufficiently correlated (e.g., relatively independent); whereas, if set parameters are sufficient correlated (e.g., relatively dependent), then the Kucherenko indices technique may be utilized.

As to the Kucherenko indices technique, an article by Kucherenko et al., entitled “Estimation of global sensitivity indices for models with dependent variables” (Computer Physics Communications, Volume 183, Issue 4, 2012, pp. 937-946, ISSN 0010-4655, https://doi.org/10.1016/j.cpc.2011.12.020), is incorporated by reference herein. The Kucherenko et al. article describes an approach for estimation variance-based sensitivity indices for models with dependent variables where both first order and total sensitivity indices may be derived as generalizations of Sobol' sensitivity indices and where a copula-based approach may be utilized for sampling from arbitrary multivariate probability distributions. The article by Kucherenko et al., indicates that behavior of sensitivity indices depends on relative predominance of interactions and correlations.

For each of a number of sites, for their respective property sets, tornado plots may be generated of total indices and/or first-order indices, which may be informative as to one or more particular site properties that contribute heavily to ranking variability and, for example, noninfluential factors. As an example, confidence intervals may be computed through bootstrap analysis, which may indicate uncertainties of sensitivity indices themselves.

As an example, a framework may be applied to field data from an existing carbon storage site selection project, which may use an Analytic Hierarchy Process (AHP) technique for criteria weighting and the Technique for Order of Preference by Similarity to Ideal Solution (TOPSIS) approach for ranking a number of sites using a number of criteria (e.g., consider 9 sites and 31 criteria, etc.). A U.S. patent application Ser. No. 18/156,700, filed 19 Jan. 2023, entitled “Carbon Sequestration and Storage Site Selection and Usage”, is incorporated by reference herein in its entirety. A U.S. patent application Ser. No. 12/147,776, filed 27 Jun. 2008, published as US20090327186A1 on 31 Dec. 2009, entitled “System and method for selecting candidates from a family of candidates”, is incorporated by reference herein in its entirety.

As explained, global sensitivity analysis may be performed using one or more techniques. For example, a framework may utilize the Sobol' indices technique first followed by applying the Kucherenko indices technique after adding correlations (e.g., positive correlation between formation permeability and porosity, etc.).

Results from a trial demonstrate that, unlike local sensitivity analysis, which tends to be based on deviations around a few reference values, global sensitivity analysis more clearly indicates the particular site properties that contribute to ranking variability along with noninfluential factors.

As an example, tornado plots may be utilized to visual and/or otherwise characterize uncertainty. For example, confidence intervals in tornado plots can indicate uncertainty of sensitivity analysis results. As an example, an analysis may be performed in iterations, for example, with noninfluential site properties in a current iteration excluded from a next iteration, which may help to reduce noise and/or simplify a model, which may provide for increasing interpretability of analysis results as well as computation efficiency. As an example, a framework may provide for grouping individual site properties into property groups as the same site property for different sites may have similar input uncertainty. Such an approach may provide a more concise and intuitive representation of the particular factors, for example, to facilitate decision-making, communications, etc.

As explained, a framework may provide for integrating the Sobol' and Kucherenko indices techniques in a manner that enables performance of global sensitivity analyses for one or more types of sites, which may include carbon storage sites (e.g., as to ranking and/or selection, even when there may be correlations between site properties). As an example, visualizations may be generated and rendered using one or more graphical user interfaces (GUIs) that include tornado plots of total indices and first-order indices with confidence intervals from bootstrap analysis that may indicate with uncertainty particularly relevant site properties, as well as, for example, noninfluential factors. As an example, a framework may provide for analyzing sensitivities of site properties through groups to discover particularly relevant factors more concisely and intuitively.

As an example, a framework may provide for carbon scoring for sites where carbon may be relevant as to a particular purpose or purposes. For example, consider a score referred to as a Carbon Storage Ranking (CSR) score; noting that other scores can be utilized for sites considered for other purposes. Such a framework may output site scores and ranking results with uncertainty through Monte Carlo simulation. Such a framework may provide for outputting information (e.g., metrics, graphics, etc.) as to which site property contributes to output uncertainty the most. As an example, a framework may also provide for sensitivity analyses that can help to determine how ranking results may change when certain input varies at some reference values. For example, a framework may provide for performing and outputting local sensitivity analysis results. However, when a system is non-linear, a framework may implement another approach, additionally or alternatively. For example, consider a framework that may implement global sensitivity analyses. In such an example, global sensitivity analyses may provide reasonable and accurate analysis results on input importance, for example, by exploring an entire input space. In addition, dependency may exist between different site properties, which tends to make an analysis more complex. As explained, a framework may provide for integrating a Sobol' indices technique and a Kucherenko indices technique for a CSR approach that enables global sensitivity analysis for CCS sites screening and/or ranking.

A Sobol' indices technique may be applied for global sensitivity analysis; noting that it applies for independent input variables. A Kucherenko indices technique, on the contrary, can provide global sensitivity analysis for dependent inputs. Hence, if an entire set of inputs are independent, a framework (e.g., a CSR framework, etc.) may use a Sobol' indices technique for global sensitivity analysis; whereas, when there is dependence between inputs, the framework may switch to a Kucherenko indices technique. In either instance, confidence intervals of different indices may be estimated by a bootstrap technique.

As to a local approach, consider a sensitivity analysis that analyzes sensitivity of site properties only at some reference points, such that it is local sensitivity analysis that does not guarantee to provide insights about how interactions between site properties can influence results (e.g., such an analysis can generate inaccurate results at times). In contrast, Sobol' indices and Kucherenko indices can achieve global sensitivity analysis by exploring an entire input parameter space. By exploring an entire input space, a framework may provide for identifying particular site properties that, for example, contribute to output uncertainty the most. Such an approach can also output information as to noninfluential inputs, which, if desired, may be removed from a model for simplicity.

As an example, a framework may integrate Sobol' indices and Kucherenko indices to enable global sensitivity analyses for site screening and/or ranking, even when dependence exists between inputs. As an example, uncertainty of an analysis, itself, may be estimated from confidence intervals by a bootstrap technique.

As an example, a framework may enable global sensitivity analysis for sites such that the framework may more readily identify particular site properties that contribute to output uncertainty (e.g., the most, the least, etc.), even when there is dependence between inputs. Such an approach can help to provide for improved data handling, transmission, selection, etc., which may help to streamline a workflow or workflows. For example, uncertainty metrics may provide for determining which characterization data are most relevant to performing a next evaluation and/or characterization phase, for example, to decrease ranking uncertainty and risk.

Site screening and ranking can involve many technical factors and may also include various non-technical factors. Factors may be evaluated for each site of a number of sites to be ranked. As some uncertainty may exist as to site property inputs, a framework may provide for outputting site scores and ranking results with uncertainty, for example, through implementation of Monte Carlo simulation. As explained, a framework may implement one or more techniques for global sensitivity analysis, for example, to generate reasonable and accurate analyses based on input relevance (e.g., importance) by exploring an entire input space.

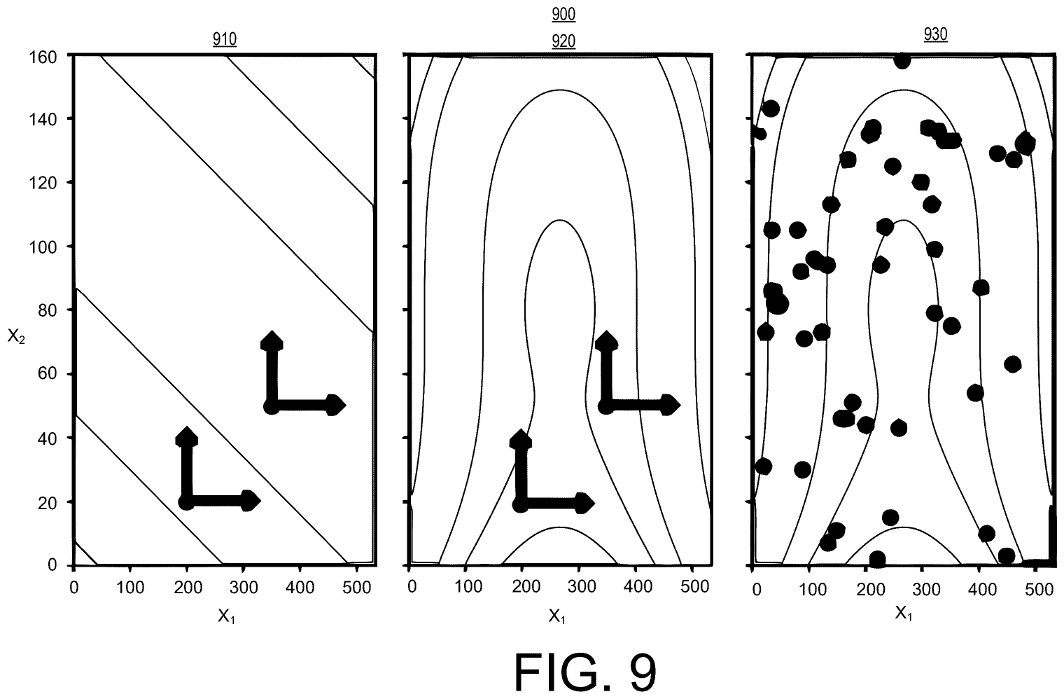

FIG. 9 shows a series of example plots 900, labeled 910, 920, and 930, where the plot 910 shows a local sensitivity analysis on a linear system, the plot 920 shows a local sensitivity analysis on a non-linear system, and the plot 930 shows a global sensitivity analysis on a non-linear system. In these plots, lines represent contours where, for example, lower values in the plot 910 may be at the upper right corner while lower values in the plots 920 and 930 may be at bottom center.

For a linear system, a local approach may provide for relevant information as to sensitivity; however, for a non-linear system, sensitivity may vary substantially in a non-linear manner such that a local approach may not provide relevant information (e.g., accurate information, etc.). Hence, for a non-linear system a global sensitivity analysis may be utilized.

As an example, a local analysis may be based on computing the effect on model output of one or more small perturbations around a nominal parameter value. In such an approach, perturbation may be performed one parameter at a time thus approximating a first-order partial derivative of model output with respect to the perturbed parameter. As an example, a global analysis may seek to explore an input parameters space (e.g., input space) across a relevant range of variation and then quantifying input parameter importance based on characterization of a resulting output response surface. As an example, for a global deterministic framework, a characterization may be aimed at identification of a non-linear system metrics such as, for example, one or more critical points (e.g., maxima, minima, saddle points, etc.). In a statistical global approach, a characterization may be aimed at measuring dispersion of output based on one or more of variance, correlation, elementary effects, etc.

As explained, Sobol' indices may be utilized for global sensitivity analyses, for example, to identify relevant inputs and, for example, noninfluential inputs when all input variables are independent. However, as explained, sometimes there may be dependence between different site properties.

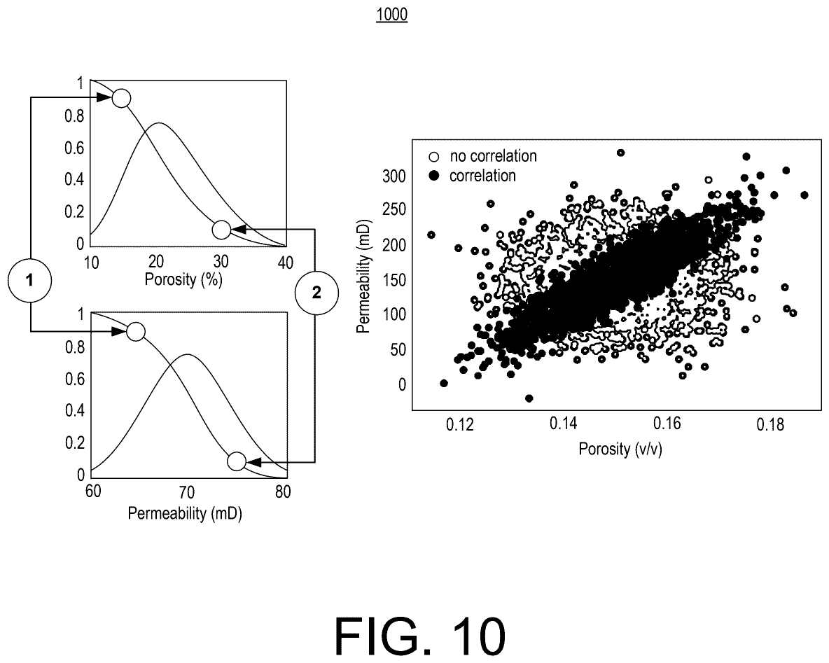

FIG. 10 shows a series of example plots 1000 that demonstrate dependence between formation porosity and permeability. As shown, in a plot of permeability versus porosity, points exist with and without correlation, as may be determined using one or more metrics (e.g., thresholds, etc.). Formation porosity and permeability tend to exhibit a positive correlation, that is, a higher porosity value maps to a higher permeability while a lower porosity value maps to a lower permeability (see, e.g., the points labeled 1 and 2). Without correlation considered during sampling, unreasonable samples may be generated, which, in turn, may cause inaccurate results in a global sensitivity analysis, which may make a Sobol' indices technique unsuitable (e.g., not valid). To address such a scenario where dependence exists, another global sensitivity analysis technique may be selected that may be able to handle dependences.

In the example plots 1000, sampling may be performed from distributions for factors, which may be, for example, technical factor and/or non-technical factors. As indicated, a technical factor may be a physical property that may characterize a subsurface formation (e.g., a reservoir, etc.). As shown, upon sampling of a permeability distribution and sampling of a porosity distribution for a particular site, based on such samplings, a framework may provide for determining whether or not some relationship exists between those two factors, which may be, for example, correlation as a type of relationship (e.g., linear and/or other). The example plots 1000 consider two factors, noting that an input space may include more factors where correlation and/or other relationships may be assessed within that input space.

As an example, a framework may provide for outputting information as to correlation and/or lack of correlation for various factors, which may be utilized to characterize one or more sites. As to ranking sites in a manner that provides for global sensitivity analysis, a framework may explore an input space for a number of sites to determine whether correlation exists or not, which may, in turn, provide for selection of an appropriate technique for sensitivity analysis (e.g., Sobol', Kucherenko, etc.). As an example, a framework may provide for sensitivity assessment for ranked sites where the type of sensitivity assessment performed may not have an impact on ranking; rather, the type of sensitivity assessment performed may provide for a more accurate understanding of sensitivity of one or more factors that contribute to ranking.

As explained, a framework may provide for assessing sites based on factors where such sites may be ranked with respect to suitability (or not) for operations, which may include, for example, carbon capture and storage (CCS) or one or more other types operations for one or more other purposes. As explained, CO2 may be injected into a reservoir at a site (e.g., a reservoir site) for effectively removing the CO2 from the atmosphere. As an example, a framework may provide for accounting for various factors relevant to such operations to determine what sites (e.g., what reservoirs) may be the most suitable. In so doing, the framework may provide for assessing one or more factors that may give rise to a high ranking and, for example, one or more other factors that may have little impact on ranking.

As an example, a framework may aim to perform site screening and ranking results in scores and ranks for a number of sites such that it can be helpful to determine which output sensitivity to be analyzed. In addition, since each site property of each site can influence final ranking results, there may be many inputs to be involved in an analysis. As an example, a framework may provide for classifying inputs in an entire input space into different groups, which may, for example, be followed by removing one or more inputs that may be deemed to be noninfluential inputs, for example, through a low-computational cost analysis as an initial analysis, followed by performing different global sensitivity analysis techniques based on whether inputs exhibit independency or dependency.

As an example, a framework may provide for classifying inputs into different groups by site property or by site, and analyzing sensitivity of different site scores, site ranks and score difference between two selected sites. As an example, a relatively low-computational cost sensitivity analysis may be executed first to screen out one or more noninfluential groups and/or inputs. In such an example, a Sobol' indices technique may be used in the case of independent inputs, while a Kucherenko indices technique may be used in the case of dependent inputs. In such an approach, global sensitivity analysis for sites screening and ranking may be performed in an improved manner.

As an example, a framework may consider multiple outputs and inputs groups. As an example, sensitivity analysis may be performed in a manner designed for certain output, while site screening and ranking results in scores, for example, to rank for sites. As an example, an approach may resort to selecting from amongst various options to determine first which output sensitivity to be analyzed. For example, consider selecting from amongst score value of a certain site, rank of a certain site, and score value difference between two selected sites.

As an example, each site property of each site may influence final ranking results; hence, there may be a relatively large number of inputs to be involved in an analysis, regardless of which output is chosen to be analyzed. As an example, to facilitate analysis, a framework may provide for classifying inputs into different groups using one or more criteria. For example, consider using site property or a site itself. In such an approach, a framework may analyze uncertainty of which site property as a group contributes output uncertainty the most, or the uncertainty within which site as a group contributes to output uncertainty the most. In addition, sensitivity on a single site property without any group may be analyzed directly to determine which certain site property contributes output uncertainty the most.

As to Sobol' indices (Sobol', 1993), they may be utilized to represent a model as a sum of component functions with increasing dimensionality. Such a representation may be referred to as a High Dimensional Model Representation (HDMR). Analogously, total variance of a model may be described in terms of the sum of the variances of the summands. Such a decomposition holds for independent input variables; noting that such a technique may be referred to as an ANOVA technique (e.g., ANalysis Of VAriance).

As an example, another manner to define importance of input Xᵢ can be to analyze how model output Y changes for different values of the variable Xᵢ, for example, via Eq. 1 and Eq. 2, below.

$${S}_{i} = \frac{{V}_{{X}_{i}} [ {E}_{{X}_{∼ i}} ( Y \vert {X}_{i} ) ]}{V ( Y )} \qquad ( 1 )$$

$${S}_{i}^{T} = \frac{{E}_{{X}_{∼ i}} [ {V}_{{X}_{i}} ( Y \vert {X}_{∼ i} ) ]}{V ( Y )} = 1 - \frac{{V}_{{X}_{∼ i}} [ {E}_{{X}_{i}} ( Y \vert {X}_{∼ i} ) ]}{V ( Y )} \qquad ( 2 )$$

where Xᵢ is the i-th input and X_{˜i} is all inputs except Xᵢ. Sᵢ is the first-order Sobol' indices, which represents the relative contribution of Xᵢ alone to the total variance;

$${S}_{i}^{T}$$

is the total Sobol' indices, which is the sum of all the Sobol' indices involving Xᵢ; further V is the variance and E is the expectation (e.g., expected value).

Eq. 1 and Eq. 2 may be computed directly in a double loop Monte Carlo (MC) estimation. However, to circumvent the expensive double loop approach, a technique described by Janon et al. (2014) may be implemented as a next estimator, for example, as expressed below in Eq. 3.

$${S}_{v} = \frac{\frac{1}{N} \sum {y}_{i} {y}_{i}^{v} - {( \frac{1}{N} \sum [ \frac{{y}_{i} + {y}_{i}^{v}}{2} ] )}^{2}}{\frac{1}{N} \sum [ \frac{{( {y}_{i} )}^{2} + {( {y}_{i}^{v} )}^{2}}{2} ] - {( \frac{1}{N} \sum [ \frac{{y}_{i} + {y}_{i}^{v}}{2} ] )}^{2}} \qquad ( 3 )$$

where

$${y}^{v} = f ( {x}_{v} , {x}_{w}^{′} ) ,$$

and

$${x}_{w}^{′}$$

is a sample of X_{w} independent of x_{w}; in Eq. 3, Sᵥ, is the Sobol' index with respect to variance.

As an example, global sensitivity analysis may aim to identify parameters (e.g., factors) whose uncertainty has the largest impact on the variability of a quantity of interest (output of the model). As an example, the Sobol' index (e.g., Sobol' sensitivity index) may be implemented as a statistical tool to quantify influence of each of a number of input variables on output (e.g., via Sobol' indices). As an example, a statistical estimation of the Sobol' index may be generated from a finite sample of model outputs (see, e.g., Janon et al., 2014).

As an example, to bypass the problem of computationally expensive model with Monte Carlo (MC) estimation, an approach described by Sudret (2008) may be implemented, which involves post-processing of polynomial chaos expansions (PCE) for sensitivity analysis, in which the Sobol' decomposition of a truncated PCE may be established analytically. As an example, PCE-based Sobol' indices may be used as a type of fast analysis, for example, to screen out one or more noninfluential groups and/or inputs.

Kucherenko indices (Kucherenko et al., 2012) utilize a direct decomposition of output variance with the law of total variance, which provides a way to generalize Sobol' indices to the case of dependent input variables. In such an approach, Eq. 1 and Eq. 2 may also be utilized to define first-order indices and total indices, which may be formally the same definitions as in the independent case, however, their estimation through Monte Carlo estimation becomes more complex. Because of dependence, fixing Xᵢ to a certain value can change the distribution of the variables correlated to Xᵢ. For example, for a given

$${X}_{i} = {x}_{i}^{*} ,$$

the other variables X_{˜i} can be sampled conditionally, which can be implemented through Gaussian copula.

As an example, a probabilistic distribution of random variables X can be displayed by their multivariant joint probability density function (PDF) or its integral, the cumulative distribution function (CDF). However, in engineering practice such a representation tends to be uncommon. Instead, a data set of each variable may be processed separately and described by a marginal distribution. In case of independence between variables, this may not be problematic; however, it may lead to inaccurate results if correlation is present. As an example, a copula approach may be employed, for example, to produce a joint CDF from the marginal distributions of the random variables, as represented by Eq. 4, below.

$${F}_{X} ( X ) = C [ {F}_{{X}_{1}} ( {X}_{1} ) , {F}_{{X}_{2}} ( {X}_{2} ) , … , {F}_{{X}_{M}} ( {X}_{M} ) ] \qquad ( 4 )$$

As an example, for a given data set, the copula may be inferred using standard statistical tools (e.g., maximum likelihood estimation). Otherwise, the copula structure may be postulated within certain parametric families. The Gaussian copula belongs to the class of elliptical copulas and can allow for implementation of a relatively expeditious isoprobabilistic transform such as the Nataf-transform.

As an example, an estimator, as represented by Eq. 5 and Eq. 6, below may be implemented for Kucherenko indices to circumvent expensive double loops:

$${S}_{v} = \frac{\frac{1}{N} \sum M ( {x}_{v , j} , {x}_{w , j} ) [ M ( {x}_{v , j} , {\overline{x}}_{w , j}^{′} ) - M ( {x}_{v , j}^{′} , {x}_{w , j}^{′} ) ]}{D} \qquad ( 5 )$$

$${S}_{v}^{T} = \frac{\frac{1}{N} \sum {[ M ( {x}_{v , j} , {x}_{w , j} ) - M ( {\overline{x}}_{v , j}^{′} , {x}_{w , j} ) ]}^{2}}{2 D} \qquad ( 6 )$$

where the samples

$$x = ( {x}_{v} , {x}_{w} ) , and {x}^{′} = ( {x}_{v}^{′} , {x}_{w}^{′} )$$

are i.i.d. samples of X; in

$$( {x}_{v} , {\overline{x}}_{w}^{′} ) ,$$

the overbar means that the marked sample

$${\overline{x}}_{w}^{′}$$

is conditioned on xᵥ.

As to the confidence interval of indices, whether for Sobol' indices or Kucherenko indices, these may be estimated, for example, via a bootstrap technique (see, e.g., Efron, 1979). As an example, a bootstrap approach may provide a relatively simple and computationally inexpensive way of estimating confidence intervals. In a relatively simple form, bootstrapping may involve resampling with replacement of new points from an original sample set without additional sampling of an original model. In such an example, an estimator of interest may then be computed for each of a number of bootstrap samples. From a resulting collection of estimators, empirical quantiles may be computed to generate confidence intervals on the interest.

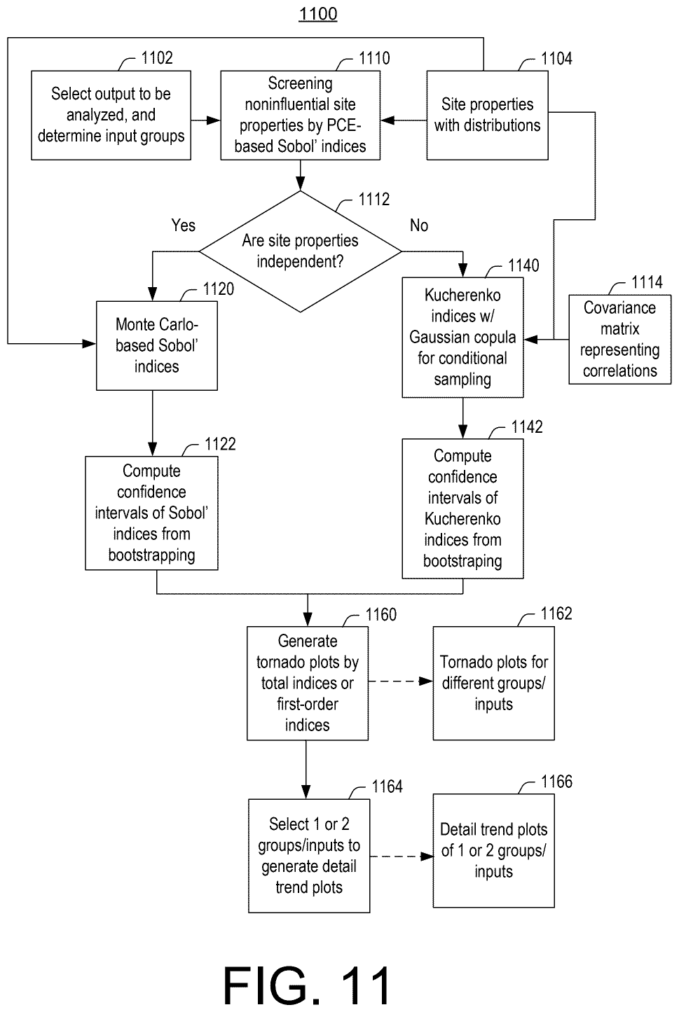

FIG. 11 shows an example of a workflow 1100 that includes various blocks that may represent sets of instructions, etc., executable by a computational framework. As shown, a selection block 1102 and a site properties with distributions block 1104 can provide selections and site properties with distributions to a screening block 1110 that may provide for screening of noninfluential site properties. As shown, a decision block 1112 can provide for deciding whether site properties are independent (e.g., or alternatively not independent or dependent). As shown, a yes branch can proceed to a Monte Carlo-based Sobol' indices block 1120 followed by a computation block 1122 for computing confidence intervals of Sobol' indices via bootstrapping; whereas, a no branch can proceed to a Kucherenko indices block 1140 that can implement Gaussian copula for conditional sampling (e.g., as may be informed by a covariance matrix block 1114, as may be linked to the site properties with distributions block 1104), followed by a computation block 1142 for computing confidence intervals of Kucherenko indices from bootstrapping. In the example of

FIG. 11, the workflow 1100 can continue to a generation block 1160 that may, for example, provide for generating tornado plots by total indices or first-order indices where, for example, per a block 1162, tornado plots may be generated for different groups/inputs. As shown, a selection block 1164 may select a number of groups and/or inputs (e.g., 1, 2, etc.) for generation of detailed trend plots where, for example, per a block 1166, detailed trend plots may be generated for selected groups and/or inputs.

As an example, a workflow may be implemented by a framework to select output to be analyzed and to determine inputs/groups. In such an example, the workflow may provide for selecting output from site scores, site ranks and score difference between two sites as a target to be analyzed. In such an example, a workflow may choose groups from site property or site itself for all input site properties, where all inputs belonging to the same group can be treated together and where sensitivity analysis may be performed on group-by-group basis.

As an example, a workflow may apply a PCE-based Sobol' indices technique to screen out noninfluential groups or site properties. As an example, based on the total Sobol' indices and the first-order Sobol' indices from PCE-based technique, a workflow may screen out one or more noninfluential groups/inputs, for example, to simplify a sensitivity analysis model.

As an example, a workflow may automatically apply one or more proper global sensitivity analysis techniques based on whether inputs are independent or not (e.g., dependent).

As an example, a framework may operate as a filter and/or a search engine. In such an example, the framework may automatically filter and/or search and then generate rankings based on assessments of factors for a number of sites. As an example, a framework may be driven by a GUI where, for example, one or more regions may be selected such that the framework operates to filter and/or search within the one or more regions for sites with commonalities in factors such that a sufficient number of common factors exist to perform an assessment of sites, which may be for purposes of ranking. As an example, a GUI may provide for user selection and/or de-selection of one or more common factors, which may, for example, result in one or more sites being excluded (e.g., for not including information as to one or more factors). As explained, through global sensitivity analysis, performed using one or more techniques in a manner that can depend on an analysis of an input space, rankings may be understood in more detail, particularly as to individual factors and/or groups of factors with respect to sensitivity.

As explained, when inputs are independent, the Sobol' indices technique may be selected and utilized to generate sensitivity results by the total Sobol' indices and the first-order Sobol' indices; whereas, when inputs are dependent, the Kucherenko indices technique may be applied to generate sensitivity results by the total Kucherenko indices and the first-order Kucherenko indices, for example, with Gaussian copula used for conditional sampling.

As an example, a workflow may include computation of confidence intervals of indices. For example, based on a defined confidence level, a framework may provide for implementation of a bootstrap technique by a workflow to compute the confidence interval of first-order Sobol' indices, the total Sobol' indices and/or the first-order Kucherenko indices and the total Kucherenko indices.

As explained, a framework may provide for generation of one or more types of plots, which may include, for example, one or more tornado plots, for example, by Sobol' indices or Kucherenko indices.

As an example, based on the Sobol' indices or Kucherenko indices a framework can generate tornado plots, for example, with decreasing order of importance of groups/inputs.

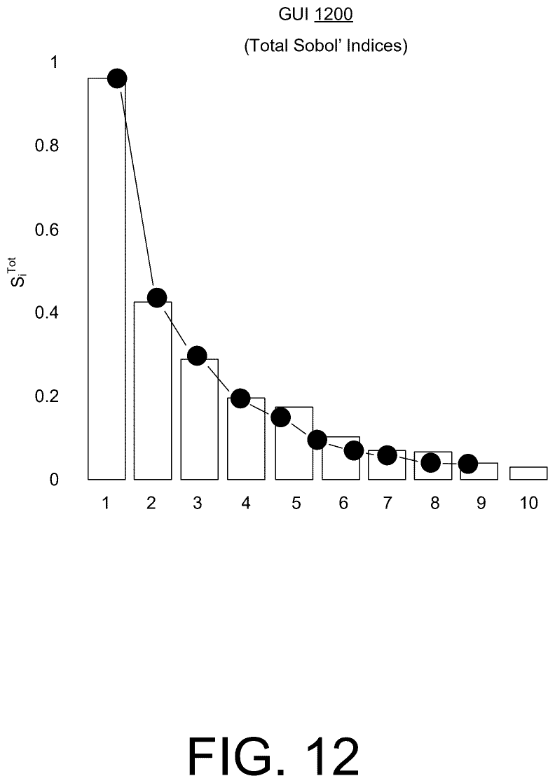

FIG. 12 shows an example of a GUI 1200 with an example plot of total Sobol' indices versus groups/inputs. Through use of tornado plots, a user may readily identify relevant groups/inputs that contribute output uncertainty the most (e.g., or least, etc.). Such an approach may help to guide users to define which characterization data are expected to be the most helpful during a subsequent evaluation and characterization phase, for example, to decrease ranking uncertainty and risk. The plot of the GUI 1200 may be represented in one or more manners, for example, consider rotation of the plot by 90 degrees to the right. As an example, global sensitivity analysis results may provide for generation of confidence intervals (e.g., using a bootstrapping approach, etc.) where confidence intervals may be rendered along with property indices (e.g., first-order, total, etc.).

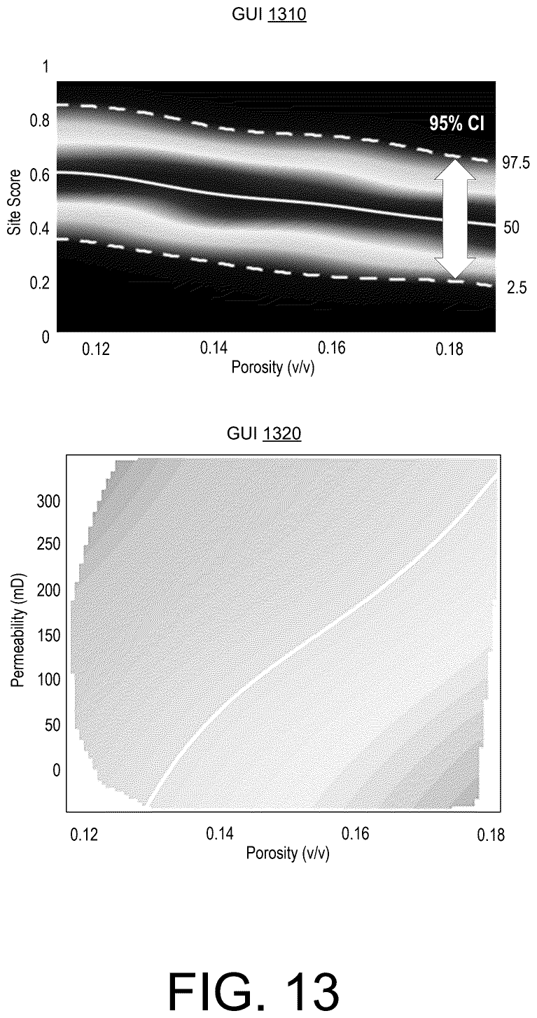

FIG. 13 shows example GUls 1310 and 1320 for sensitivity analysis, for example, using PDF trend plots. As an example, after finding out the most important groups/inputs through tornado plots, a framework may provide for selection of a group/input and analyze its detail probability density function (PDF) change through a trend plot. In the examples of FIG. 13, the plot of the GUI 1310 displays an example of reservoir porosity whose total Sobol' indices PDF changing within range, with low probability and high probability, which may be color or otherwise coded. As an example, a framework may provide for selection of more than one group/input. For example, consider selection of two groups/inputs to generate bi-variable trend plots. In the examples of FIG. 13, the GUI 1320 shows an example of permeability versus porosity, with a white line representing a P50 of site score, which may be coded with respect to score.

In the example GUI 1310, the plot shows a 95 percent confidence interval corresponding to uncertainties in all other parameters for site score distribution with respect to porosity as a factor (e.g., a property). For example, with porosity of 0.15, the site score P50 value is approximately 0.5 where the site score distribution ranges from approximately 0.25 at P2.5 to approximately 0.75 at P97.5. As shown, the site score distribution and P50 value can depend on the porosity (e.g., as a factor). As shown, the GUI 1310 provides for assessment of a score for a single site with respect to a single factor; whereas, the GUI 1320 shows site score P50 value as a line with respect to two factors.

As an example, one or more other techniques may be implemented. For example, consider ANCOVA (Analysis of Covariance) indices (Caniou, 2012), also called SCSA (Structural and Correlated Sensitivity Analysis), which is global sensitivity analysis technique for dependent input variables, which uses PCE for HDMR and splits the first-order indices into three parts (e.g., uncorrelated, interactive, correlated) by decomposition of covariance. Such an approach may act as an alternative to a Kucherenko indices technique.

As an example, a Low-Rank Approximation (LRA) based Sobol' indices technique may act as an alternative of PCE-based Sobol' indices technique for screening out one or more noninfluential site properties.

As an example, a framework may provide for implementing a method of applying global sensitivity analysis for site screening and ranking, identifying the most important and noninfluential site properties (e.g., factors), whether site properties are independent or dependent. As an example, a framework may provide for implementing a method for guiding data collections to decrease uncertainty of screening and ranking results for a project.

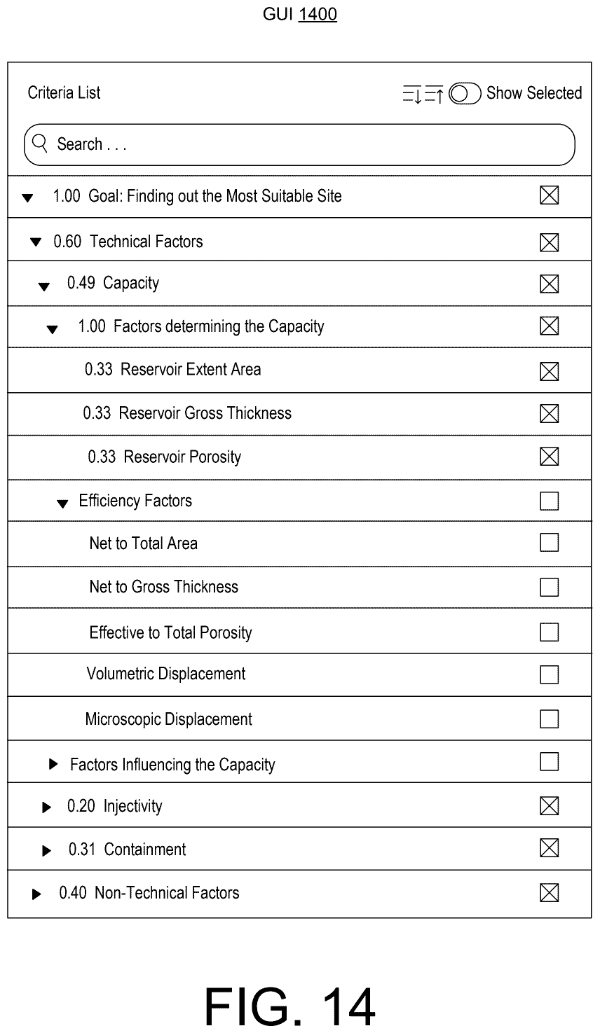

FIG. 14 shows an example of a GUI 1400 that includes various graphical controls that may be selectable via interactions with the GUI 1400 and/or automatically by a framework. As an example, upon selection of a number of sites, which may be via one or more criteria, a GUI may be generated that includes a set of common factors. In such an approach, a user may interact with the GUI (e.g., as rendered to a display device) to select a number of the common factors. As an example, such factors may be site properties. As an example, the GUI 1400 may operate in a reverse manner whereby upon selection of a set of factors, a framework may determine which sites may be assessed (e.g., ranked, etc.), for example, according to factors in common.

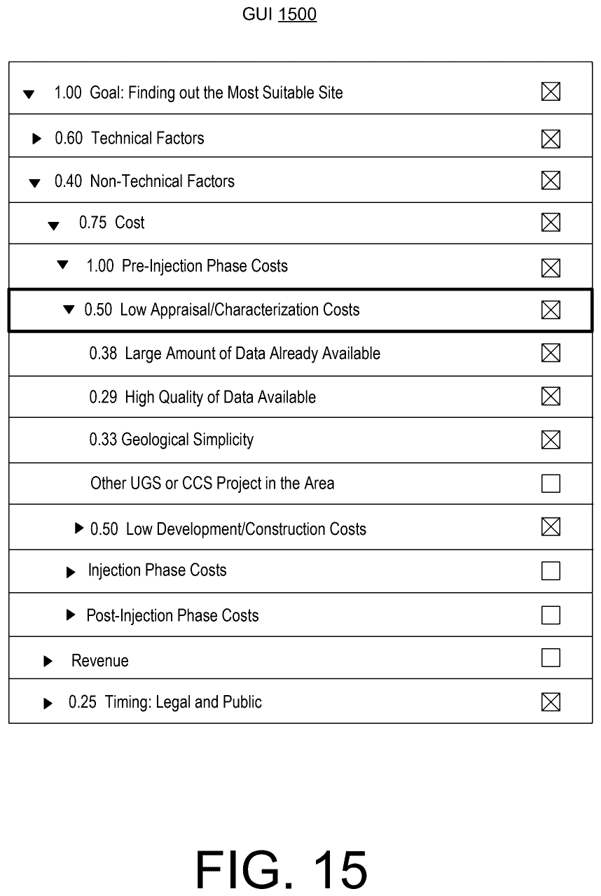

FIG. 15 shows an example of a GUI 1500 that includes various graphical controls that may be selectable via interactions with the GUI 1500 and/or automatically by a framework. As an example, upon selection of a number of sites, which may be via one or more criteria, a GUI may be generated that includes a set of common factors. In such an approach, a user may interact with the GUI (e.g., as rendered to a display device) to select a number of the common factors. As an example, such factors may be site properties. As an example, the GUI 1500 may operate in a reverse manner whereby upon selection of a set of factors, a framework may determine which sites may be assessed (e.g., ranked, etc.), for example, according to factors in common.

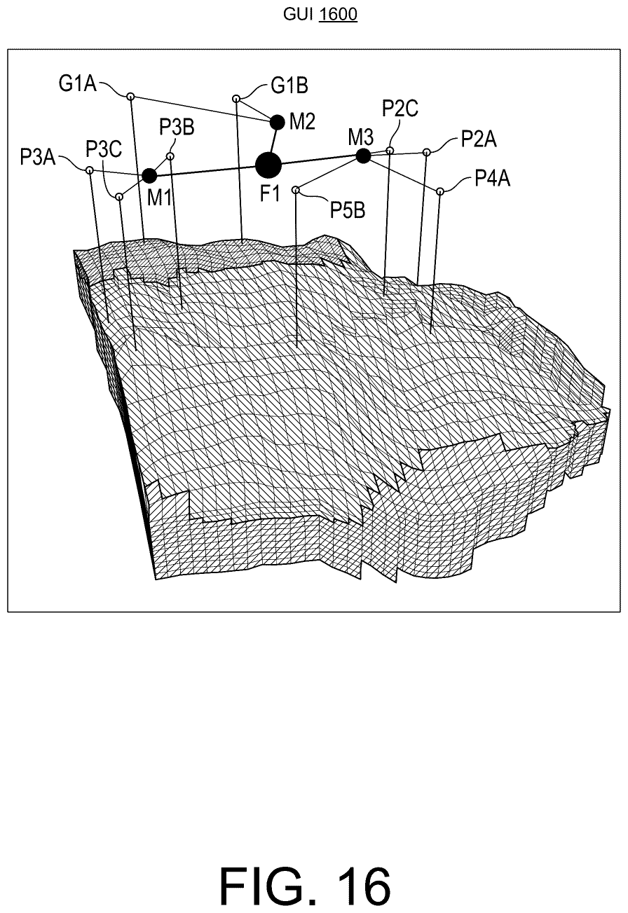

FIG. 16 shows an example of a GUI 1600 that includes a rendering of a reservoir model, which may be a ranked model of a framework. In such an example, where development is present, the GUI 1600 may show various equipment, wells, etc., which may provide for assessment of the site (e.g., reservoir site) for use of such equipment for one or more purposes. As an example, the GUI 1600 may be dynamic and driven by a framework. For example, as mentioned, a framework may provide for accessing data, generating data, etc. In such an example, the GUI 1600 may be dynamically updated, for example, responsive to receipt of data, whether actual and/or synthetic (e.g., via simulation, etc.).

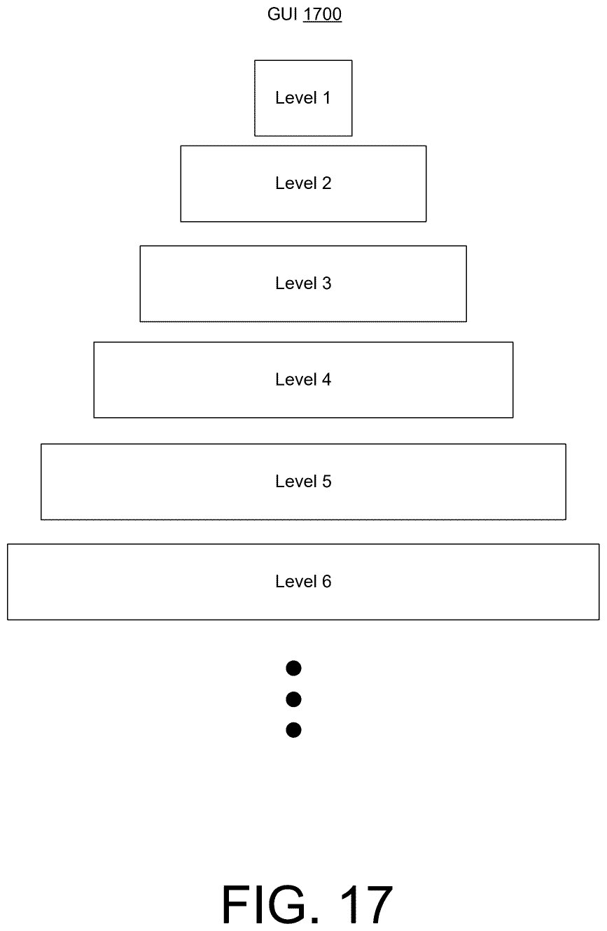

FIG. 17 shows an example of a GUI 1700 that may provide for navigation of factors, which may be via a hierarchy (e.g., arranged as levels, etc.). As an example, at level 1, factors may be technical or non-technical; at level 2, factors may be directed to capacity, injectivity, containment, cost, revenue, timing, etc.; at level 3, factors may be related to determining higher factors, determining performance, impact of loss of containment, pre-injection costs, injection costs, potential EOR/EGR, legal/regulatory, credit availability, etc.; at level 4, factors may include Efficiency Factors, Openness of the Reservoir, Homogeneous, Connected Depositional Environment, Lateral Continuity, Stacking Pattern, Reservoir Permeability, Reservoir Gross Thickness, Pore Pressure, Minimum Horizontal stress gradient for the storage interval, Net to Gross Thickness, Openness of the Reservoir, Salinity of the Reservoir Water, Geological Containment, Well Integrity, Impact on Health and Safety (People), Impact on the Environment, Impact on Costs, Impact on the Image of the Company, Low Appraisal/Characterization Costs, Low Injection, OPEX Excluding Monitoring (Few/Cheap Injection Wells), Injection, etc.; at level 5, factors may include Net to Total Area, Net to Gross Thickness, Effective to Total Porosity, Volumetric Displacement, Microscopic Displacement, Trapping in the Reservoir, Containment Performance of the Primary Seal, Containment Performance of the Bounding Fault, Containment Performance of the Natural Fractures, Containment Performance of the Secondary Seal, Number of Additional Caprock Before the First Drinkable Aquifer or the Storage, Depth of the Reservoir, Structural Dip, Containment Performance of the Open Wells, Containment Performance of the Plugged Wells, Few New Wells (Containment Performance of New Injectors and Monitoring Wells), Sparsely Populated Area, Absence of Public Building or Public Activities, No Risk of CO2 Concentration, Low Impact on Subsurface Water, No Significant Surface Water Use, Low Impact on Plants or Animals, Low Impact on the Soil (Soil Reactivity), Additional Monitoring Costs, Low Workover Costs, Low Lost due to Surrender of Carbon Credits, Large Amount of Data Already Available, High Quality of Data Available, Geological Simplicity, Other UGS or CCS Project in the Area, Low CAPEX Injector Wells, Low CAPEX Injector Wells, Cheap/Few Pressure Release Wells, Cheap/Few Monitoring Wells, Cheap/Few Remediation of Legacy Wells, Low Transport Costs, Low Monitoring Costs, No/Low Additional Costs due to Injectivity Lower than Expected (likelihood*costs), Years of Post Injection Monitoring, Number of Wells, Local, State/Country, Federal/Union, Legal Feasibility of CCS, Distance from Border, Easy Exploration/Drilling Permitting, Easy Injection Permitting, Easy Pipeline Permitting, No Local Government Additional Regulation, Ease of Obtaining Right of Way for Transmission Lines, Simple Site Ownership, Simple Subsurface Water Rights, Pore Space Right, Easy Access to the Site, No Overlapping Mineral Rights, No Known Regulation to CCS/Awareness of the Public on CCS, Level of NGO Awareness and Support, Level of Local Community Associations Awareness and Support, No Existence of Industrial Failure in the Area, Existence of Risky Projects in the Area, Low Seismicity in the Area, etc.; at level 6, factors may include Large Volume of CO2 Trapped by Capillarity, Large Volume of CO2 Dissolved in Brine, Large Volume of CO2 Absorbed in Coal (ECBM only), Intrinsic Containment, Containment for CO2 Storage, Fault Permeability, Fault Stability, Fault Intensity, Intrinsic Containment, Structure Closure of the Secondary Storage Horizon, Number of Open Wells, Quality of the Cement at the time of the Cementing Job (If No Cement Evaluation Log is Available), Quality of the Cement at the Time Of Job (from Cement Evaluation Logs), Limited Cement Degradation Since the Job Time, Caprock Creep, Number of Plugged Wells, Design and Quality of the Plugging, Strong Winds, Favorable Topography, Drinkable/Agricultural/ASR, Other Use (Industry/Geothermal . . . ), No Fishing/Farming Area, No Natural Protected Area, No Protected Species in the Area, etc.; at yet another level, factors may include Seal Permeability, Seal Thickness, Seal Lateral Homogeneity, Seal Lithology, Integrity under Pressure/Temperature Variation, Integrity under Chemical Variation, Stress Anisotropy (Distance of horizontal stress from vertical), Seal rock strength, in-situ minimum horizontal stress in seal, Fraction of the Caprock Covered by the Cement, Number of Centralizer Across the Caprock, Well Deviation, Minimum Average Well Age, Cement Quality Facing the Primary Caprock of Open Wells, Cement Quality Facing Other Caprocks of Open Wells, Low Aggressivity of the Formation, Smooth Utilization of the Well over Time, Cement Quality Facing the Primary Caprock of Plugged Wells, Cement Quality Facing Other Caprocks of Plugged Wells, Low Depth of the Reservoir, Onshore/Offshore, Number of Monitoring Wells Required, Depth of the Monitoring Wells, Depth of the Wells to be Remediated, Short Distance from Power Plant, Transport Method (e.g., pipeline, ships, trucks, etc.), Small Surface Site Area, Geology Simplicity, Depth, Good Site Accessibility, Number of Injector Wells, Monitoring of the CO2 Plume Feasible, etc.

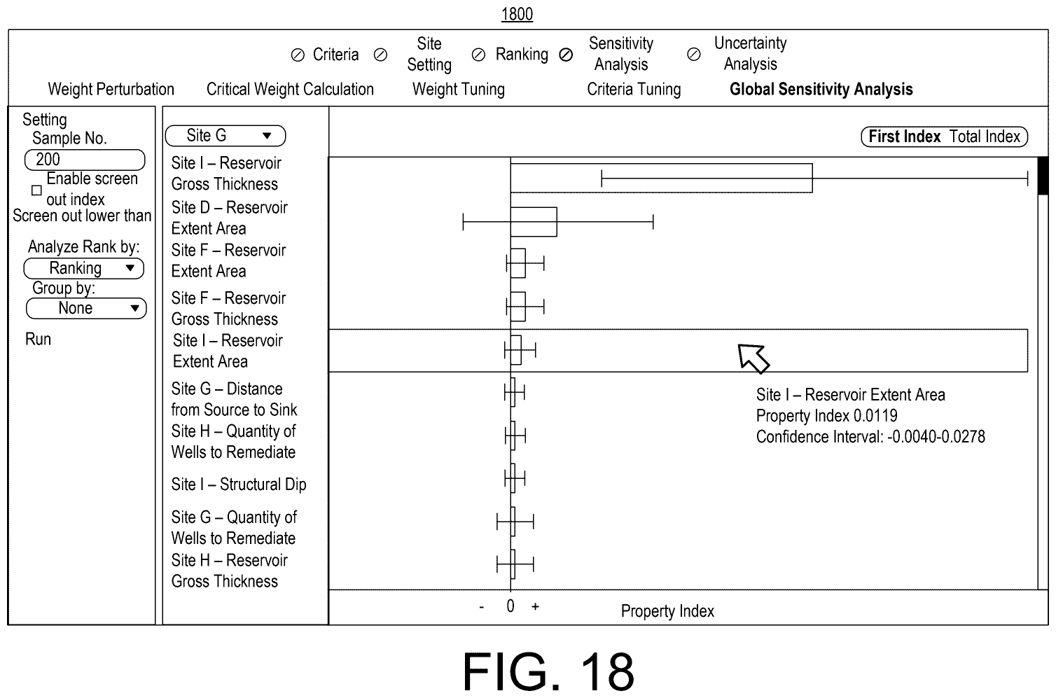

FIG. 18 shows an example of a GUI 1800 that can include a rendering of one or more types of plots (e.g., graphs, etc.). As shown, the GUI 1800 may provide for rendering graphics, text, numeral, etc., as to various aspects of sites as may be ranked where the GUI 1800 may provide for ranking of various factors based on results of a global sensitivity analysis. As indicated in the GUI 1800, a method may include selection of criteria (e.g., factors), selection of site settings (e.g., automatically, semi-automatically, etc.), ranking of sites, performing a sensitivity analysis of an input space (e.g., corresponding to the criteria), and performing an uncertainty analysis based on results of the sensitivity analysis. As shown, a method may include performing weight perturbation, critical weight calculation, weight tuning, criteria tuning, and global sensitivity analysis.

In the example of FIG. 18, a graphic may be a plot that renders information as to a first index and/or total index. As shown, the plot may provide factors (e.g., properties) with respective property indices along with confidence intervals with respect to each of the factors (e.g., properties). As shown, a factor may be selected such that the GUI 1800 renders information such as the property index (e.g., a factor index) for a site (e.g., Site I, Reservoir Extent Area) and confidence interval for the property index (e.g., confidence interval (CI) for a factor index). As shown, the GUI 1800 can include a setting panel with various selectable options and an execution (run) button (e.g., graphical control). In such an example, the execution button may be actuated to cause a rendering of one or more graphics as to ranking.

As an example, uncertainty may increase or decrease with respect to sampling number. For example, as shown in the setting panel, a sample number is set to 200. In the GUI 1800, a user may adjust the sample number, for example, to make it larger or smaller. In such an approach, results may be generated where property index values and confidence intervals may change.

As an example, the GUI 1800 may be dynamic and may be linked to one or more sources of data. For example, as data may change, become available, etc., the GUI 1800 may automatically update in response to receipt of such data. For example, consider data from field exploration, satellite observation, modeling, simulation, field operations, etc. In such an approach, a framework may provide for trending. For example, consider a site or sites that become more or less suitable or ranked depending on a reduction in uncertainty coming from additional data. In such an approach, if a site is trending downward responsive to receipt of reliable data, then it may be likely that it will continue to trend downward once additional knowledge is taken into account. In such an example, a source or sources of error and/or uncertainty may be assessed, which may facilitate or otherwise improve making assessments as to sites and ranking thereof for one or more purposes.

As explained, a framework may provide for a global sensitivity analysis that may be performed for purposes of performing an uncertainty analysis as to various factors upon which various sites are ranked. In such an example, a ranking of sites may be explored with respect to uncertainty as to various factors that underlie the ranking of the sites. Further, various factors themselves may be ranked as to their respective factor indices (e.g., property indices). As explained, confidence intervals (CIs) may be generated for factors with respect to their respective factor indices (e.g., property indices). As an example, a confidence interval can be generated that gives an indication of the degree of uncertainty of an estimate (e.g., a property index), which may help to ascertain estimation precision. A confidence interval may specify a range of values likely to contain an unknown population value, which may be defined by a lower limit and/or an upper limit; noting that a value may be practically limited (e.g., as not being negative, not being less than zero, etc.).

As explained, a framework may provide for performing a global sensitivity analysis on factors that define an input space where distributions are provided for the factors for each of a number of sites. As explained, one or more pre-processing techniques may be applied prior to performing a global sensitivity analysis where, for example, a pre-processing technique may include determining whether factors within an input space are dependent or independent, as may be determined via correlation techniques using, for example, one or more classification criteria (e.g., to classify as dependent, as independent, as not dependent, as not independent, etc.). As explained, a global sensitivity analysis technique may be selected based on an assessment of factors within an input space such that an uncertainty analysis may be more accurate, for example, to assess a ranking of sites, which may be with respect to a particular goal (e.g., suitability for carbon capture and storage, etc.).

As explained, a global sensitivity analysis may provide for assessing site properties that contribute the most to ranking results variability for ranking of a number of sites, which may, for example, provide guidance for data collection in a subsequent evaluation and characterization phase to decrease uncertainty and risk within site ranking and selection.

As explained, a framework may generate tornado plots of total indices and first-order indices (e.g., first indices) that can help discern particular site properties that contribute the most to ranking variability, as well as noninfluential factors, while confidence intervals may be computed through bootstrap analysis that can indicate uncertainties of sensitivity indices themselves. As an example, confidence intervals in tornado plots can indicate uncertainty of sensitivity analysis results.

As to ranking of sites, as explained, an Analytic Hierarchy Process (AHP) method for criteria weighting and Technique for Order of Preference by Similarity to Ideal Solution (TOPSIS) approach may be implemented for ranking a number of sites against a number of factors (e.g., criteria).

As explained, an analysis may be performed in iterations, with noninfluential site properties in a current iteration excluded from a next iteration, which can help to reduce noise and simplify a model, which may increase interpretability of analysis results as well as computation efficiency. As explained, site factors may be grouped into property groups because the same site property for different sites may have similar input uncertainty, which may provide for a more concise and intuitive representation of the particularly relevant factors.

As an example, a framework can output site scores and ranking results with uncertainty through Monte Carlo simulation. Such a framework can provide for determining which site property contributes to output uncertainty the most. Such a framework may also provide for determining how ranking results will change when certain input varies at some reference values. As an example, a framework may operate using local sensitivity analysis for linear systems and may operate using global sensitivity analysis for non-linear systems. As to non-linear systems, global sensitivity analysis may be implemented to give reasonable and accurate analysis on input importance by exploring an entire input space. In various instances, dependency may exist between different site properties, which can make an analysis more complex. As explained, a framework may selectively implement a Sobol' indices technique or a Kucherenko indices technique for global sensitivity analysis, which may be applied for sites screening and ranking.

As explained, after implementing an appropriate global sensitivity analysis technique, confidence intervals for different indices may be estimated, for example, via a bootstrap technique.

As explained, a site may be a reservoir site where, for example, injection of CO2 may be part of an operational scheme that may facilitate recovery of one or more fluids from a reservoir. For example, consider EOR and/or EGR. As an example, injection of CO2 may increase pressure in a reservoir to enhance production of one or more other fluids. As explained, one or more factors may relate to EOR and/or EGR.

An international patent application, filed pursuant to the Patent Cooperation Treaty (PCT), having Serial No. PCT/US2022/051401, filed 30 Nov. 2022, and published as WO2023102046A1, 8 Jun. 2023, entitled “Hydrate Operations System”, is incorporated by reference herein in its entirety, and describes, for example, performing a reservoir simulation for injection of carbon dioxide into a reservoir via an injection well; during the performing, accessing a trained machine learning model that outputs hydrate information based on reservoir conditions; and, based on the hydrate information, generating reservoir simulation results that indicate an amount of the carbon dioxide sequestered in the reservoir. As an example, a framework may provide for assessing one or more sites that may be suitable (or not) for carbon dioxide sequestration based at least in part on hydrate information (e.g., clathrates, etc.). For example, the GUI 800 of FIG. 8 may provide for indicating sites, ranked sites, selected sites, etc., which may be interactive, dynamic, etc., as to site assessment based on one or more factors.

As an example, a simulator such as, for example, the INTERSECT simulator, may provide for output of various values. As an example, a reservoir simulation workflow and an assessment workflow may be linked (e.g., to provide for CO2 related property computations, etc.). As an example, data may include measured data and/or synthetic data, which may be via simulation, machine learning techniques, etc.

As an example, a framework may operate using one or more types of coding. For example, consider JSON, PYTHON, etc., which may provide for a relatively lightweight implementation in terms of operability with one or more other frameworks and/or environments (e.g., consider the DELFI environment). As an example, a platform such as the DATAIKU platform may be utilized, which includes various data science capabilities (e.g., programmable artificial intelligence, machine learning, statistics, computational formulas, libraries, etc.). As another example, consider the TIBCO SPOTFIRE platform, which may be integrated with the DATAIKU platform.

As an example, a framework may be utilized to generate data for storage, for example, as a database, data table, proxy model, one or more types of machine learning (ML) models. In such an example, a proxy model may have input tailored for one or more workflows (e.g., consider realization studies for sensitivity analysis, etc.). As an example, a proxy model may be operable as a lightweight simulation model that can generate results more expeditiously than a full physics-based simulator.

As an example, one or more ML model techniques may be utilized, which may be for regression (prediction) and/or for classification. As an example, a combined ML model for regression (prediction) and classification can be for determining the age of an abalone from physical details, where predicting the number of rings of the abalone is a proxy for the age of the abalone (e.g., age can be predicted as both a numerical value (in years) or a class label (ordinal year as a class)). In various examples, a trained ML model may output probability information. For example, consider a probability that input belongs to a particular class.

As to some types of ML models, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network (CNN), stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine learning model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

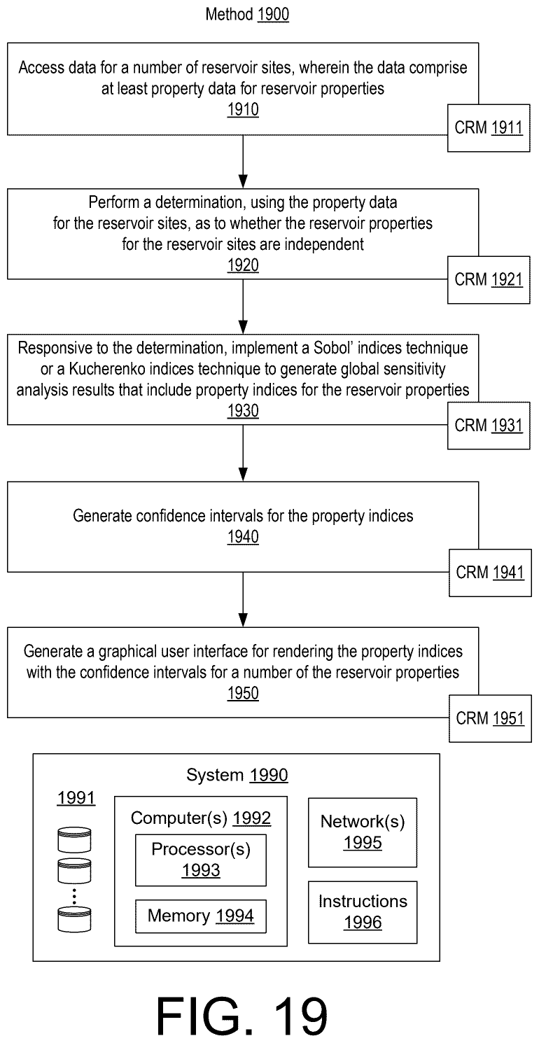

FIG. 19 shows an example of a method 1900 and an example of a system 1990. As shown, the method 1900 can include an access block 1910 for accessing data for a number of reservoir sites, where the data include at least property data for reservoir properties; a performance block 1920 for performing a determination, using the property data for the reservoir sites, as to whether the reservoir properties for the reservoir sites are independent; an implementation block 1930 for, responsive to the determination, implementing a Sobol' indices technique or a Kucherenko indices technique to generate global sensitivity analysis results that include property indices for the reservoir properties; a generation block 1940 for generating confidence intervals for the property indices; and a generation block 1950 for generating a graphical user interface for rendering the property indices with the confidence intervals for a number of the reservoir properties.

The method 1900 is shown as including various computer-readable storage medium (CRM) blocks 1911, 1921, 1931, 1941, and 1951 that can include processor-executable instructions that can instruct a computing system, which can be a control system, to perform one or more of the actions described with respect to the method 1900.

In the example of FIG. 19, the system 1990 includes one or more information storage devices 1991, one or more computers 1992, one or more networks 1995 and instructions 1996. As to the one or more computers 1992, each computer may include one or more processors (e.g., or processing cores) 1993 and memory 1994 for storing the instructions 1996, for example, executable by at least one of the one or more processors 1993 (see, e.g., the blocks 1911, 1921, 1931, 1941, and 1951). As an example, a computer may include one or more network interfaces (e.g., wired or wireless), one or more graphics cards, a display interface (e.g., wired or wireless), etc.

As an example, a method can include accessing data for a number of reservoir sites, where the data include at least property data for reservoir properties; performing a determination, using the property data for the reservoir sites, as to whether the reservoir properties for the reservoir sites are independent; responsive to the determination, implementing a Sobol' indices technique or a Kucherenko indices technique to generate global sensitivity analysis results that include property indices for the reservoir properties; generating confidence intervals for the property indices; and generating a graphical user interface for rendering the property indices with the confidence intervals for a number of the reservoir properties.

As an example, implementing may implement the Sobol' indices technique where a determination indicates that reservoir properties for sites are independent. As an example, implementing may implement the Kucherenko indices technique where a determination indicates that reservoir properties for sites are not independent.

As an example, performing may utilize one or more correlation criteria for a determination as to whether reservoir properties for sites are independent.

As an example, a method may include selecting reservoir properties from a group of reservoir properties common to a number of reservoir sites.

As an example, a method may be performed for a first selected set of reservoir properties and for a second selected set of reservoir properties, where implementing implements the Sobol' indices technique for the first set, as being independent, and where implementing implements the Kucherenko indices technique for the second set, as not being independent.

As an example, a method may include ranking reservoir sites with respect to suitability for one or more purposes. In such an example, the ranking can depend on at least in part on property data for reservoir properties. As an example, ranking may utilize an Analytic Hierarchy Process (AHP) technique for criteria weighting and a Technique for Order of Preference by Similarity to Ideal Solution (TOPSIS). As explained, purposes may include, for example, mining-related, carbon-related, hydrocarbon-related, nuclear-related, geothermal-related, etc.

As an example, a method may include generating confidence intervals by implementing a bootstrapping technique.

As an example, a method may include identifying one of a number of property indices as being the most important and/or identifying one or more of a number of property indices as being noninfluential. As an example, a method may include excluding one or more reservoir properties based on one or more property indices being noninfluential. In such an example, the method may include performing a ranking analysis of reservoir sites without the excluded one or more of the reservoir properties.

As an example, a method may include assessing a ranking of reservoir sites based at least in part on rendering of property indices with confidence intervals.

As an example, a method may include decreasing uncertainty of ranked results for reservoir sites based at least in part on rendering of property indices with confidence intervals.

As an example, a method may include excluding noninfluential reservoir properties prior to performing a determination as to independence and/or dependence. In such an example, the method may include implementing a polynomial chaos expansions-based Sobol' indices technique.

As an example, a system can include a processor; a memory accessibly by the processor; and instructions stored in the memory and executable by the processor to instruct the system to: access data for a number of reservoir sites, where the data include at least property data for reservoir properties; perform a determination, using the property data for the reservoir sites, as to whether the reservoir properties for the reservoir sites are independent; responsive to the determination, implement a Sobol' indices technique or a Kucherenko indices technique to generate global sensitivity analysis results that include property indices for the reservoir properties; generate confidence intervals for the property indices; and generate a graphical user interface for rendering the property indices with the confidence intervals for a number of the reservoir properties.

As an example, one or more computer-readable storage media can include processor-executable instructions where the processor-executable instructions include instructions to instruct a computing system to: access data for a number of reservoir sites, where the data include at least property data for reservoir properties; perform a determination, using the property data for the reservoir sites, as to whether the reservoir properties for the reservoir sites are independent; responsive to the determination, implement a Sobol' indices technique or a Kucherenko indices technique to generate global sensitivity analysis results that include property indices for the reservoir properties; generate confidence intervals for the property indices; and generate a graphical user interface for rendering the property indices with the confidence intervals for a number of the reservoir properties.

As an example, a computer program product can include one or more computer-readable storage media that can include processor-executable instructions to instruct a computing system to perform one or more methods and/or one or more portions of a method.

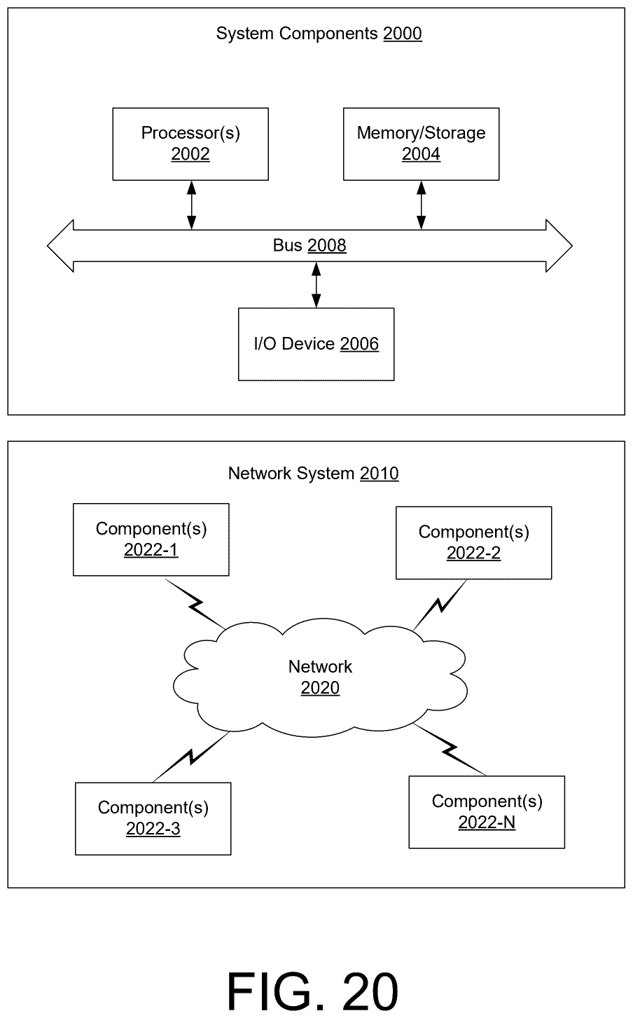

FIG. 20 shows components of an example of a computing system 2000 and an example of a networked system 2010 with a network 2020. The system 2000 includes one or more processors 2002, memory and/or storage components 2004, one or more input and/or output devices 2006 and a bus 2008. In an example embodiment, instructions may be stored in one or more computer-readable media (e.g., memory/storage components 2004). Such instructions may be read by one or more processors (e.g., the processor(s) 2002) via a communication bus (e.g., the bus 2008), which may be wired or wireless. The one or more processors may execute such instructions to implement (wholly or in part) one or more attributes (e.g., as part of a method). A user may view output from and interact with a process via an I/O device (e.g., the device 2006). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 2010. The network system 2010 includes components 2022-1, 2022-2, 2022-3, . . . 2022-N. For example, the components 2022-1 may include the processor(s) 2002 while the component(s) 2022-3 may include memory accessible by the processor(s) 2002. Further, the component(s) 2022-2 may include an I/O device for display and optionally interaction with a method. The network 2020 may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

### References Incorporated by Reference Herein in Their Entirety

Caniou, Y. (2012). Global sensitivity analysis for nested and multiscale models. Ph. D. thesis, Universite Blaise Pascal, Clermont-Ferrand. 10, 11, 18, 19
Efron, B. (1979). Bootstrap methods: another look at the Jackknife. Annals of Statistics 7(1), 1-26. 18
Janon, A., T. Klein, A. Lagnoux, M. Nodet, and C. Prieur (2014). Asymptotic normality and efficiency of two Sobol' index estimators. ESAIM: Probability and Statistics 18, 342-364.15, 65
Kucherenko, S., S. Tarantola, and P. Annoni (2012). Estimation of global sensitivity indices for models with dependent variables. Computer Physics Communications 183, 937-946. 20, 21, 22
Sobol', I. M. (1993). Sensitivity estimates for nonlinear mathematical models. 1(4), 407-414. 12, 13, 65
Sudret, B. (2008). Global sensitivity analysis using polynomial chaos expansions. Reliability Engineering & System Safety 93(7), 964-979. 16

What is claimed is:

1. A method comprising:
accessing data for a number of reservoir sites, wherein the data comprise at least property data for reservoir properties;
performing a determination, using the property data for the reservoir sites, as to whether the reservoir properties for the reservoir sites are independent;
responsive to the determination, implementing a Sobol' indices technique or a Kucherenko indices technique to generate global sensitivity analysis results that comprise property indices for the reservoir properties;
generating confidence intervals for the property indices; and
generating a graphical user interface for rendering the property indices with the confidence intervals for a number of the reservoir properties.

2. The method of claim 1, wherein the implementing implements the Sobol' indices technique where the determination indicates that the reservoir properties for the reservoir sites are independent.

3. The method of claim 1, wherein the implementing implements the Kucherenko indices technique where the determination indicates that the reservoir properties for the reservoir sites are not independent.

4. The method of claim 1, wherein the performing utilizes one or more correlation criteria for the determination as to whether the reservoir properties for the reservoir sites are independent.

5. The method of claim 1, comprising selecting the reservoir properties from a group of reservoir properties common to the number of reservoir sites.

6. The method of claim 1, comprising performing the method of claim 1 for a first selected set of reservoir properties and for a second selected set of reservoir properties, wherein the implementing implements the Sobol' indices technique for the first set, as being independent, and wherein the implementing implements the Kucherenko indices technique for the second set, as not being independent.

7. The method of claim 1, comprising ranking the reservoir sites with respect to suitability for one or more purposes.

8. The method of claim 7, wherein the ranking depends on at least in part on the property data for the reservoir properties.

9. The method of claim 7, wherein the ranking utilizes an Analytic Hierarchy Process (AHP) technique for criteria weighting and a Technique for Order of Preference by Similarity to Ideal Solution (TOPSIS).

10. The method of claim 1, wherein the generating the confidence intervals comprises implementing a bootstrapping technique.

11. The method of claim 1, comprising identifying one of the property indices as being the most important.

12. The method of claim 1, comprising identifying one or more of the property indices as being noninfluential.

13. The method of claim 12, comprising excluding one or more of the reservoir properties based on the one or more of the property indices being noninfluential.

14. The method of claim 13, comprising performing a ranking analysis of the reservoir sites without the excluded one or more of the reservoir properties.

15. The method of claim 1, comprising assessing a ranking of the reservoir sites based at least in part on the rendering of the property indices with the confidence intervals.

16. The method of claim 1, comprising decreasing uncertainty of ranked results for the reservoir sites based at least in part on the rendering of the property indices with the confidence intervals.

17. The method of claim 1, comprising excluding noninfluential reservoir properties prior to the performing the determination.

18. The method of claim 17, wherein the excluding comprises implementing a polynomial chaos expansions-based Sobol' indices technique.

19. A system comprising:
a processor;
a memory accessibly by the processor; and
instructions stored in the memory and executable by the processor to instruct the system to:
access data for a number of reservoir sites, wherein the data comprise at least property data for reservoir properties;
perform a determination, using the property data for the reservoir sites, as to whether the reservoir properties for the reservoir sites are independent;
responsive to the determination, implement a Sobol' indices technique or a Kucherenko indices technique to generate global sensitivity analysis results that comprise property indices for the reservoir properties;
generate confidence intervals for the property indices; and
generate a graphical user interface for rendering the property indices with the confidence intervals for a number of the reservoir properties.

20. One or more computer-readable storage media comprising processor-executable instructions wherein the processor-executable instructions comprise instructions to instruct a computing system to:
access data for a number of reservoir sites, wherein the data comprise at least property data for reservoir properties;
perform a determination, using the property data for the reservoir sites, as to whether the reservoir properties for the reservoir sites are independent;
responsive to the determination, implement a Sobol' indices technique or a Kucherenko indices technique to generate global sensitivity analysis results that comprise property indices for the reservoir properties;
generate confidence intervals for the property indices; and
generate a graphical user interface for rendering the property indices with the confidence intervals for a number of the reservoir properties.
